(19) United States
(12) Patent Application Publication
(10) Pub. No.: US 2023/0369600 A1
(43) Pub. Date: Nov. 16, 2023

(54) ELECTRODE COMPOSITION, ELECTRODE SHEET FOR ALL-SOLID STATE SECONDARY BATTERY, AND ALL-SOLID STATE SECONDARY BATTERY, AND MANUFACTURING METHODS FOR ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Hideyuki SUZUKI, Kanagawa (JP)

(73) Assignee: FUJIFILM Corporation, Tokyo (JP)

(21) Appl. No.: 18/361,902

(22) Filed: Jul. 30, 2023

Related U.S. Application Data
(63) Continuation of application No. PCT/JP2022/013527, filed on Mar. 23, 2022.

(30) Foreign Application Priority Data
Mar. 26, 2021 (JP) 2021-053905

(51) Int. Cl. H01M 4/62; H01M 10/0562

(52) U.S. Cl. CPC H01M 4/622; H01M 10/0562; H01M 4/624; H01M 2004/021

(57) ABSTRACT

There is provided an electrode composition containing an inorganic solid electrolyte (SE), an active material (AC), a conductive auxiliary agent (CA), a polymer binder (B), and a dispersion medium (D), where the polymer binder (B) being includes a polymer binder (B1) that is dissolved in the dispersion medium (D) and the electrode composition satisfies specific conditions (1) to (4), and there are provided an electrode sheet for an all-solid state secondary battery and an all-solid state secondary battery, and manufacturing methods for an electrode sheet for an all-solid state secondary battery and an all-solid state secondary battery, in which the electrode composition is used.

### CROSS-REFERENCE TO RELATED APPLICATIONS

This application is a Continuation of PCT International Application No. PCT/JP2022/013527 filed on Mar. 23, 2022, which claims priority under 35 U.S.C. § 119 (a) to Japanese Patent Application No. 2021-053905 filed in Japan on Mar. 26, 2021. Each of the above applications is hereby expressly incorporated by reference, in its entirety, into the present application.

### BACKGROUND OF THE INVENTION

### 1. Field of the Invention

The present invention relates to an electrode composition, an electrode sheet for an all-solid state secondary battery, and an all-solid state secondary battery, and manufacturing methods for an electrode sheet for an all-solid state secondary battery and an all-solid state secondary battery.

### 2. Description of the Related Art

A secondary battery is a storage battery including a negative electrode, a positive electrode, and an electrolyte sandwiched between the negative electrode and the positive electrode, and it enables charging and discharging by the reciprocal migration of specific metal ions such as lithium ions between both electrodes.

As such a secondary battery, a non-aqueous electrolyte secondary battery using an organic electrolytic solution has been used in a wide range of use applications. However, for the purpose of further improving battery performance such as rate characteristics and self-discharge amount, research on an electrode, a material for forming the electrode, and the like is underway. For example, JP2018-073687A discloses “a positive electrode for a lithium secondary battery, in which an electrode mixture layer that contains a positive electrode active material for a lithium secondary battery, containing secondary particles obtained by aggregating primary particles capable of being dope and dedoped with lithium ions, a conductive material, and a binder, and a current collector are laminated, where the positive electrode for a lithium secondary battery is characterized in that a 180-degree peel strength between the collector and the electrode mixture layer is 140 N/m or more, and a BET specific surface area of the electrode mixture layer is 4.0 to 8.5 m²/g”, and further discloses “a paste of a positive electrode forming mixture” for producing this positive electrode for a lithium secondary battery. In addition, JP2017-188455A discloses a dispersion liquid in which a coated positive electrode active material for a lithium ion battery, obtained by coating, at a specific coverage, at least a part of the surface of the positive electrode active material for a lithium ion battery with a coating layer containing a polymeric compound and a conductive agent, and a conductive material are dispersed in a dispersion medium to be formed into a slurry.

However, in the non-aqueous electrolyte secondary battery using an organic electrolytic solution, liquid leakage easily occurs, and a short circuit easily occurs in the inside of the battery due to overcharging or overdischarging. As a result, there is a demand for additional improvement in safety and reliability.

Under these circumstances, an all-solid state secondary battery in which an inorganic solid electrolyte is used instead of the organic electrolytic solution has attracted attention. In this all-solid state secondary battery, a negative electrode, an electrolyte, and a positive electrode are all solid, and the safety or reliability of batteries including an organic electrolytic solution can be significantly improved. It is also said to be capable of extending the battery life. Further, the all-solid state secondary battery can have a structure in which the electrodes and the electrolyte are directly disposed in series. Therefore, the energy density can be further increased as compared to a non-aqueous electrolyte secondary battery in which an organic electrolytic solution is used, and the application to an electric vehicle or a large-sized storage battery is expected.

A constitutional layer of a secondary battery, irrespective of whether the secondary battery is a non-aqueous electrolyte secondary battery or an all-solid state secondary battery, generally is formed into a film by using a slurry composition obtained by dispersing or dissolving a material that forms the constitutional layer in a dispersion medium as described in JP2018-073687A and JP2017-188455A.

By the way, as substances that form constitutional layers of the all-solid state secondary battery, inorganic solid electrolytes, particularly an oxide-based inorganic solid electrolyte and a sulfide-based inorganic solid electrolyte have been in the limelight in recent years as electrolyte materials having a high ion conductivity comparable to that of the organic electrolytic solution. However, as a material that forms an active material layer (an active material layer forming material) of an all-solid state secondary battery, the material (the electrode composition) containing the above-described inorganic solid electrolyte, active material, or the like has not been studied JP2018-073687A and JP2017-188455A.

### SUMMARY OF THE INVENTION

In a case of forming an active material layer with solid particle materials (an inorganic solid electrolyte, an active material, conductive auxiliary agent, and the like), from the viewpoint of the improvement of the battery performance (for example, rate characteristics and cycle characteristics) of the all-solid state secondary battery, it is desirable that an active material layer forming material has excellent dispersion stability that stably maintains good initial dispersibility of a solid particle material (also referred to as solid particles) immediately after preparation of an active material layer forming material (the initial dispersibility and the dispersion stability are collectively referred to as dispersion characteristics), and furthermore, excellent characteristics such as application suitability such as characteristics (surface properties) of facilitating the formation of a coating film having a flat surface and characteristics of firmly adhering solid particles (adhesiveness).

As such an active material layer forming material, the use of a high-concentration composition (a concentrated slurry) having an increased concentration of solid contents has been studied from the viewpoints of reducing the burden on the environment in recent years and furthermore, reducing the manufacturing cost. However, as the concentration of solid contents of the composition is increased, the characteristics of the composition generally deteriorate significantly. The same applies to the above-described dispersion characteristics, application suitability, and the like, and it is not easy to realize the required dispersion characteristics, application suitability, and the like in a high-concentration composition.

An object of the present invention is to provide an electrode composition having excellent dispersion characteristics and excellent application suitability even in a case where the concentration of solid contents is increased. In addition, another object of the present invention is to provide an electrode sheet for an all-solid state secondary battery and an all-solid state secondary battery, and manufacturing methods for an electrode sheet for an all-solid state secondary battery and an all-solid state secondary battery, in which the above electrode composition is used.

As a result of advancing diligent studies on the electrode composition, the inventors of the present invention got an idea that although some improvement effect can be expected regarding the dispersion characteristics of the inorganic solid electrolyte by the selection, improvement, and the like of the kind (chemical structure) and content of the polymer binder, the overall improvement of the behavior of the polymer binder with respect to solid particles in a dispersion medium leads to the improvement of dispersion characteristics and application suitability, in an electrode composition in which a conductive auxiliary agent and an active material, which have deteriorated dispersion characteristics with respect to a dispersion medium, are present together.

As a result of further studies based on this idea, the inventors of the present invention found that in a case of, for example, dissolving the polymer binder in a dispersion medium and then reinforcing the affinity (interaction) with the solid particles, the electrode composition can achieve both excellent dispersion characteristics and excellent application suitability even in a case where it contains a conductive auxiliary agent and an active material, which have deteriorated dispersion characteristics, and furthermore, even in a case where the concentration of solid contents is increased. That is, it was found that in a case where a polymer binder that dissolves in a dispersion medium is used in combination with the solid particles, and the following conditions (1) to (4) are satisfied, the above-described affinity of the polymer binder can be stably exhibited, the solid particles can be stably dispersed not only immediately after the adjustment of the electrode composition but also after a lapse of time (has excellent dispersion characteristics) even in a case where the concentration of solid contents is increased, and furthermore, the solid particles can firmly adhere in the formation of a film of the electrode composition, and the coated surface is flat, whereby the surface properties are improved (application suitability is excellent). Further, it was also found that in a case of using this electrode composition as an active material layer forming material, an active material layer having excellent surface properties and excellent adhesiveness can be realized, and an all-solid state secondary battery into which this active material layer is incorporated as an electrode can realize excellent rate characteristics.

The present invention has been completed through further studies based on these findings.

That is, the above problems have been solved by the following means.

<1> An electrode composition comprising:
an inorganic solid electrolyte (SE) having an ion conductivity of a metal belonging to Group 1 or Group 2 of the periodic table;
an active material (AC);
a conductive auxiliary agent (CA);
a polymer binder (B); and
a dispersion medium (D),
wherein the polymer binder (B) includes a polymer binder (B1) that is dissolved in the dispersion medium (D), and
the polymer binder (B1), the inorganic solid electrolyte (SE), the active material (AC), and the conductive auxiliary agent (CA) satisfy the following conditions (1) to (4),
(1) a mass average molecular weight of a polymer constituting the polymer binder (B1) is 100,000 to 2,000,000,
(2) a value of a polarity element of surface energy of the polymer constituting the polymer binder (B1) is 0.5 mJ/m² or more,
(3) a content of the polymer binder (B1) in a total solid content is 1.5% by mass or less,
(4) a total product of a specific surface area and a content mass fraction of each of the inorganic solid electrolyte (SE), the active material (AC), and the conductive auxiliary agent (CA) is 5.0 to 15.0 m²/g.

<2> The electrode composition according to <1>, in which the dispersion medium (D) has an SP value of 17 to 22 MPa^{1/2}.

<3> The electrode composition according to <1> or <2>, in which the value of the polarity element is 1.0 mJ/m² or more.

<4> The electrode composition according to any one of <1> to <3>, in which the polymer constituting the polymer binder (B1) contains a constitutional component having a substituent having 8 or more carbon atoms, as a side chain.

<5> The electrode composition according to any one of <1> to <4>, in which the polymer binder (B) includes a polymer binder (B2) composed of a polymer having a molecular weight different from that of the polymer binder (B1).

<6> The electrode composition according to <5>, in which the mass average molecular weight of the polymer constituting the polymer binder (B1) is 200,000 or more, and a mass average molecular weight of the polymer constituting the polymer binder (B2) is 200,000 or less.

<7> The electrode composition according to any one of <1> to <6>, in which in a case where a viscosity at a shear rate of 10 s⁻¹ and a viscosity at a shear rate of 20 s⁻¹ are measured for the electrode composition, and a power approximation expression is created in terms of orthogonal coordinates where a lateral axis indicates the shear rate and a vertical axis indicates the viscosity, an approximate value of a viscosity at a shear rate of 1 s⁻¹ is 5,000 cP or more, and an absolute value of an exponent part of the power approximation expression is 0.6 or less.

<8> An electrode sheet for an all-solid state secondary battery, comprising:
an active material layer formed of the electrode composition according to any one of <1> to <7>.

<9> An all-solid state secondary battery comprising, in the following order:
a positive electrode active material layer;
a solid electrolyte layer; and
a negative electrode active material layer,
in which at least one layer of the positive electrode active material layer or the negative electrode active material layer is an active material layer formed of the electrode composition according to any one of <1> to <7>.

<10> A manufacturing method for an electrode sheet for an all-solid state secondary battery, the manufacturing method comprising:
forming a film of the electrode composition according to any one of <1> to <7>.

<11> A manufacturing method for an all-solid state secondary battery, comprising:
manufacturing an all-solid state secondary battery through the manufacturing method according to <10>.

The present invention can provide an electrode composition excellent in dispersion characteristics (initial dispersibility and dispersion stability) and application suitability (surface properties and adhesiveness) even in a case where the concentration of solid contents is increased. In addition, according to the present invention, it is possible to provide an electrode sheet for an all-solid state secondary battery and an all-solid state secondary battery, which have an active material layer formed of the above electrode composition. Further, according to the present invention, it is possible to provide manufacturing methods for an electrode sheet for an all-solid state secondary battery and an all-solid state secondary battery, in which the above electrode composition is used.

The above-described and other characteristics and advantages of the present invention will be further clarified by the following description with appropriate reference to the accompanying drawing.

### BRIEF DESCRIPTION OF THE DRAWINGS

FIG. 1 is a longitudinal cross-sectional view schematically illustrating an all-solid state secondary battery according to a preferred embodiment of the present invention.

### DESCRIPTION OF THE PREFERRED EMBODIMENTS

In the present invention, a numerical value range indicated using “to” means a range including numerical values before and after the “to” as the lower limit value and the upper limit value. In a case where a plurality of numerical value ranges are set and described for the content, physical properties, and the like of a component in the present invention, the upper limit value and the lower limit value, which form each of the numerical value ranges, are not limited to a specific combination described before and after “to” as a specific numerical value range and can be set to a numerical value range obtained by appropriately combining the upper limit value and the lower limit value of each numerical value range.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. In addition, a polymer binder (also simply referred to as a binder) means a binder formed of a polymer and includes a polymer itself and a binder constituted (formed) by containing a polymer.

In the present invention, a composition containing an inorganic solid electrolyte, an active material, and a conductive auxiliary agent and used as a material (an active material layer forming material) that forms an active material layer of an all-solid state secondary battery is referred to as an electrode composition (also referred to as an electrode composition for an all-solid state secondary battery). On the other hand, a composition containing an inorganic solid electrolyte and used as a material that forms a solid electrolyte layer of an all-solid state secondary battery is referred to as an inorganic solid electrolyte-containing composition, where this composition generally does not contain an active material and the conductive auxiliary agent.

In the present invention, the electrode composition includes a positive electrode composition containing a positive electrode active material and a negative electrode composition containing a negative electrode active material. Therefore, any one of the positive electrode composition and the negative electrode composition, or collectively both of them may be simply referred to as an electrode composition, and any one of the positive electrode active material layer and the negative electrode active material layer, or collectively both of them may be simply referred to as an active material layer or an electrode active material layer. Further, in the present invention, any one of the positive electrode active material and the negative electrode active material, or collectively both of them may be simply referred to as an active material or an electrode active material.

[Electrode Composition]

The electrode composition according to the present invention contains an inorganic solid electrolyte (SE) having an ion conductivity of a metal belonging to Group 1 or Group 2 of the periodic table, an active material (AC), a conductive auxiliary agent (CA), a polymer binder (B), and a dispersion medium (D). This polymer binder (B) includes one or two or more kinds of polymer binders (B1) that are dissolved in a dispersion medium, and the polymer binder (B1), the inorganic solid electrolyte (SE), the active material (AC), and the conductive auxiliary agent (CA) satisfy the conditions (1) to (4) described later.

In the dispersion medium (D), according to the electrode composition according to the embodiment of the present invention, which employs the polymer binder (B1) as the polymer binder (B) used in combination with the solid particles of the inorganic solid electrolyte (SE), the active material (AC), and the conductive auxiliary agent (CA), the solid particles can be stably dispersed not only immediately after the adjustment but also after a lapse of time (has excellent dispersion characteristics) even in a case where the concentration of solid contents of the electrode composition is increased, and furthermore, the solid particles can firmly adhere in the formation of a film of the electrode composition, and the coated surface is flat, whereby the surface properties are improved (application suitability is excellent). Therefore, in a case of using this electrode composition as an active material layer forming material, it is possible to produce an active material layer having excellent surface properties and furthermore, excellent adhesiveness and realize an all-solid state secondary battery exhibiting excellent rate characteristics.

Although the details of the reason for the above are not yet clear, they are conceived to be as follows.

In a case where the polymer binder (B1), which is soluble in the dispersion medium (D), is allowed to suitably exhibit the affinity for the solid particles (the condition (2)), and then allowed to have an increased molecular weight in a specific range (the condition (1)), it is conceived that the molecular chain of the polymer binder (B1) in the dispersion medium spreads, and the firmly adsorbed solid particles are allowed to repel with each other to exhibit a thickening effect while effectively suppressing (re)aggregation or precipitation (exhibit excellent dispersion stability) even in a case where an active material and a conductive auxiliary agent, which have deteriorated dispersibility with respect to solid particles. In particular, even in a case of a conductive auxiliary agent that is difficult to be dispersed uniformly and easily aggregates, the (re)aggregation or the like can be suppressed, whereby dispersibility can be improved. Further, in a case of setting the specific surface area of the solid particles in a specific range (the condition (4)) coupled with setting the content to be small (the condition (3)), it is conceived that, without excessively coating the surface of the solid particles even in a case where the polymer binder (B1) is allowed to have an increased molecular weight, the direct contact between the solid particles (without interposing the polymer binder (B1)) is ensured while maintaining the dispersion characteristics and the firm adsorption, whereby a conduction path having a small interface resistance can be sufficiently constructed.

Due to the above-described action, even at the formation of a film of an active material layer (for example, at the time of the application and furthermore at the time of drying of the electrode composition), it is conceived that it is possible to suppress the generation of reaggregates, sediments, or the like of the solid particles, and it is possible to uniformly dispose the solid particles by suppressing the variation in the contact state between the solid particles in the active material layer (the solid particles are less likely to be unevenly distributed). In addition, at the time of the film formation, a viscosity (fluidity) suitable for film formation can be exhibited in addition to the improvement of the dispersion characteristics. As a result, it is conceived that the occurrence of the rugged unevenness on the coated surface coated with the electrode composition can be suppressed, and moreover, the solid particles can firmly adhere (the application suitability is excellent).

In a case of forming an active material layer by using such an electrode composition having excellent dispersion characteristics and excellent application suitability, it is possible to form an active material layer having a flat surface by firmly adhering the solid particles while suppressing the uneven distribution and moreover ensuring the direct contact of the solid particles. In particular, it is possible to enhance the dispersibility of the conductive auxiliary agent which is responsible for electron conductivity, and it is possible to realize excellent electron conductivity (the construction of sufficient conduction paths over the entire layer). Therefore, it is conceived that an all-solid state secondary battery into which this active material layer is incorporated exhibits the rate characteristics.

In a case where the electrode composition according to the embodiment of the present invention is formed into a film on the surface of a collector, it is conceived that excellent dispersion characteristics are maintained even at the time of film formation. Therefore, an active material layer to be formed can firmly adhere to a collector without the contact (adhesion) of the polymer binder (B1) with the surface of the collector being inhibited by the solid particles which are preferentially sedimented.

In the electrode composition according to the embodiment of the present invention, it is conceived that, as described above, the polymer binder (B1) has a function of adsorbing to the solid particles of the inorganic solid electrolyte (SE), the active material (AC), and the conductive auxiliary agent (CA) or dispersing the particles in the dispersion medium (D) by being interposed therebetween. Here, the adsorption of the polymer binder (B1) to the solid particles is not particularly limited; however, it includes not only physical adsorption but also chemical adsorption (adsorption by chemical bond formation, adsorption by transfer of electrons, or the like).

On the other hand, the polymer binder (B1) functions, in the active material layer, as a binder that binds the inorganic solid electrolyte (SE), the active material (AC), and the conductive auxiliary agent (CA). In addition, it may also function as a binder that binds a collector to solid particles.

The polymer binder (B1) contained in the electrode composition according to the embodiment of the present invention exhibits characteristics (solubility) of being soluble in the dispersion medium (D). The polymer binder (B1) in the electrode composition generally is present in a state of being dissolved in the dispersion medium (D) in the electrode composition, which depends on the dispersion medium (D). In this case, the polymer binder (B1) stably exhibits the function of dispersing solid particles in the dispersion medium.

In the present invention, the description that the polymer binder is dissolved in a dispersion medium means that a polymer binder is dissolved in a dispersion medium of the electrode composition, and for example, it means that the solubility is 10% by mass or more in the solubility measurement. On the other hand, the description that the polymer binder is not dissolved (is insoluble) in a dispersion medium means that the solubility in the solubility measurement is less than 10% by mass.

The measuring method for solubility is as follows. That is, a specified amount of a polymer binder serving as a measurement target is weighed in a glass bottle, 100 g of a dispersion medium that is the same kind as the dispersion medium contained in the electrode composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the polymer binder dissolved (the above-described specified amount), and the upper limit concentration X (% by mass) at which the transmittance is 99.8% is defined as the solubility of the polymer binder in the above dispersion medium.

<Transmittance Measurement Conditions>
Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

The electrode composition according to the embodiment of the present invention contains solid particles of the inorganic solid electrolyte (SE), the active material (AC), the conductive auxiliary agent (CA), the dispersion medium (D), and the polymer binder (B1). In addition, the electrode composition imparts, to the polymer binder (B1), characteristics of being soluble in the dispersion medium (D), and satisfies the following conditions (1) to (4). This makes it possible to realize excellent dispersion characteristics and excellent application suitability, and it is possible to maintain excellent dispersion characteristics and excellent application suitability even in a case where the concentration is increased.

The condition (1): The mass average molecular weight of a polymer constituting the polymer binder (B1) is 100,000 to 2,000,000.

In an electrode composition containing the above components, in a case where the condition (1) is combined with the solubility of the polymer binder (B1) and other conditions, the molecular chain (molecular structure) spreads in the dispersion medium and adsorbed or adjacent solid particles are allowed to repel with each other, whereby aggregation can be effectively suppressed, and a high thickening effect is exhibited, whereby the sedimentation of the solid particles can be suppressed. As a result, it is possible to realize not only excellent initial dispersibility but also high dispersion stability. From the viewpoint that more excellent dispersion characteristics can be realized, the mass average molecular weight of the polymer is preferably 200,000 or more, more preferably 250,000 or more, and still more preferably 300,000 or more. The upper limit is preferably 1,500,000 or less, more preferably 1,000,000 or less, and still more preferably 700,000 or less.

The mass average molecular weight of the polymer (b1) can be appropriately adjusted by changing the kind, content, polymerization time, polymerization temperature, and the like of the polymerization initiator.

—Measurement of Molecular Weight—

In the present invention, unless specified otherwise, molecular weights of a polymer and a macromonomer refer to a mass average molecular weight and number average molecular weight in terms of standard polystyrene conversion, which are determined by gel permeation chromatography (GPC). The measuring method thereof includes, basically, a method under Conditions 1 or Conditions 2 (preferential) described below. However, depending on the kind of polymer or macromonomer, an appropriate eluent may be suitably selected and used.

(Condition 1)
Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

(Condition 2)
Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive index (RI) detector

Condition (2): A value of a polarity element of surface energy of the polymer constituting the polymer binder (B1) is 0.5 mJ/m² or more.

In an electrode composition containing the above components, in a case where the condition (2) is combined with the solubility of the polymer binder (B1) and other conditions, the polymer binder (B1) adsorbs to the inorganic solid electrolyte (SE) and the active material (AC), which have a polar surface, while being dissolved in the dispersion medium (D), whereby the inorganic solid electrolyte and the active material can be dispersed highly even in a case where the dispersion medium has a low polarity. In addition, since the molecular chain of the polymer binder which has adsorbed to the inorganic solid electrolyte and the active material spreads in the solvent, the conductive auxiliary agent (CA) can be highly dispersed. From the viewpoint of further improving the dispersion characteristics of the inorganic solid electrolyte and the active material, which have adhered more firmly, and the dispersion characteristics of the conductive auxiliary agent due to the spreading of the molecular chain of the polymer binder, the value of the polarity element of the surface energy of the polymer constituting the polymer binder (B1) is preferably 1.0 mJ/m² or more and still more preferably 1.5 mJ/m² or more. The upper limit value thereof is not particularly limited; however, it is practically 20 mJ/m² or less, and it is preferably 10 mJ/m² or less and more preferably 5.0 mJ/m² or less.

The value of the polarity element can be appropriately adjusted depending on the kind (details thereof will be described later) or the amount of the polar group to be introduced into the polymer, and furthermore the arrangement of the polar group at the time of introduction, and the like.

The value of the polarity element (also referred to as a polarity component) of the surface energy of the polymer can be determined as follows.

(1) Production of Polymer Film

In order to determine the value of the polarity element, first, a polymer film is produced.

Specifically, 100 μL of a polymer solution obtained by dissolving a polymer constituting the polymer binder (B1) in a dispersion medium is applied onto a silicon wafer (3×N type, manufactured by AS ONE Corporation) with a spin coater under the following conditions, followed by vacuum drying at 100° C. for 2 hours to produce a polymer film. It is noted that the dispersion medium that is used for the preparation of the polymer solution shall be the same as the dispersion medium that is used in combination with the polymer binder (B1) in Examples described later.
—Coating Conditions—
Concentration of polymer solution: 10% by mass
Rotation speed of spin coater: 2,000 rpm
Rotation time of spin coater: 5 seconds

(2) Measurement of Contact Angle θ

The contact angles θ of the three kinds of dispersion media (hexadecane, ethylene glycol, or bromonaphthalene) with respect to the polymer film produced on the silicon wafer as described above are each measured according to the θ/2 method in the liquid droplet method. Here, an angle (an angle inside the liquid droplet), which is formed by the sample surface (the surface of a polymer film) and a liquid droplet after 200 milliseconds after the liquid droplet has been brought into contact with the surface of the polymer film and attached thereto, is defined as the contact angle θ. It is noted that the contact angle θ of each dispersion medium shall be an average value of the measured values obtained by carrying out the above-described measurement four times.

(3) Derivation of Polarity Element of Surface Energy

The value of the polarity component (mN/m) is obtained by substituting each of the obtained contact angles θ into the following Fowkes equation and solving binary simultaneous equations for the dispersion component Y=γ_{SV}^{d} and the polarity component X=γ_{SV}^{h}.

$$\sqrt{γ {SV}^{d} γ {LV}^{d}} + \sqrt{γ {SV}^{h} γ {LV}^{h}} = \frac{γ L ( 1 + cos Θ )}{2}$$

It is noted that γ_{LV}^{h} and γ_{LV}^{d} are known constants determined from the surface tension γ_{L} of each dispersion medium. For example, in a case of hexadecane, they are respectively as follows: γ_{LV}^{d}=44.4 mN/m, and γ_{LV}^{h}=0.2 mN/m.

The condition (3): A content of the polymer binder (B1) in a total solid content of the electrode composition is 1.5% by mass or less.

In an electrode composition containing the above components, in a case where the condition (3) is combined with the solubility of the polymer binder (B1) and other conditions, particularly coupled with the increase in molecular weight (the condition (1)), it is possible to reduce the content of the polymer binder as an insulating component while maintaining the adsorption quantity of the solid particles due to the polymer, and it is possible to prevent the deterioration of battery characteristics such as rate characteristics. From the viewpoint that more excellent battery characteristics can be realized, the content of the polymer binder (B1) is preferably 1.2% by mass or less and more preferably 1.0% by mass or less. The lower limit value may be any value more than 0% by mass; however, it is practically 0.1% by mass or more, and it is preferably 0.2% by mass or more and more preferably 0.5% by mass or more.

In the present invention, the solid content (solid component) refers to components that neither volatilize nor evaporate and disappear in a case where the electrode composition is subjected to drying treatment at 150° C. for 6 hours in a nitrogen atmosphere at a pressure of 1 mmHg. Typically, the solid content refers to a component other than the dispersion medium (D) described later. In addition, the content in the total solid content indicates the content in 100% by mass of the total mass of the solid content.

The condition (4): A total product of a specific surface area and a content mass fraction of each of the inorganic solid electrolyte (SE), the active material (AC), and the conductive auxiliary agent (CA) is 5.0 to 15.0 m²/g.

In an electrode composition containing the above components, in a case where the condition (4) is combined with the solubility of the polymer binder (B1) and other conditions, the surface of these solid particles is suitably coated with the polymer binder (B1), whereby it is possible to achieve both the exhibition of the dispersion characteristics and adhesive force and the direct contact state between the solid particles (the suppression of the increase in interface resistance) in a well-balanced manner. From the viewpoint that the dispersion characteristics and the adhesiveness as well as the contact state can be further improved, the total product of the specific surface area and the content mass fraction is preferably 6.0 to 14.0 m²/g, more preferably 7.0 to 13.0 m²/g, and still more preferably 8.0 to 12.0 m²/g.

In the present invention, the total product of the specific surface area and the content mass fraction refers to a total of a product of a specific surface area of the inorganic solid electrolyte (SE) and a mass fraction (content rate) in the electrode composition, a product of a specific surface area of the active material (AC) and the mass fraction (content rate), and a product of a specific surface area of the conductive auxiliary agent (CA) and the mass fraction (content rate), and it has the same meaning as the specific surface area as an electrode forming mixture (electrode forming particles) consisting of the above-described three components. The total product is determined up to the first decimal place by rounding off the calculated value to the second decimal place. The component constituting the electrode forming mixture does not include the polymer binder and other components described later.

The specific surface area of the electrode forming mixture can be appropriately adjusted depending on the specific surface area and content rate of each component, and furthermore the mixing conditions and the like.

The specific surface area of each of the inorganic solid electrolyte (SE), the active material (AC), and the conductive auxiliary agent (CA) is not particularly limited and appropriately determined in consideration of the specific surface area of the electrode forming mixture.

The specific surface area of the inorganic solid electrolyte (SE) is generally in a range of 0.1 to 100 m²/g. However, among the above, it is preferably in a range of 1.0 to 80 m²/g, more preferably in a range of 5.0 to 50 m²/g, and still more preferably in a range of 10 to 40 m²/g, from the viewpoint of increasing the contact area with the active material and increasing the ion conductivity. The specific surface area of the inorganic solid electrolyte (SE) can be adjusted within the above-described range by changing a particle diameter adjusting method (condition) and micronizing conditions (for example, mechanical milling conditions in Examples) described later.

The specific surface area of the active material (AC is generally in a range of 0.1 to 50 m²/g. However, among the above, it is preferably in a range of 0.5 to 40 m²/g, more preferably in a range of 1.0 to 30 m²/g, still more preferably in a range of 2.0 to 20 m²/g, and particularly preferably 2.0 to 10 m² or less, from the viewpoint of increasing the contact area with the solid electrolyte and increasing the ion conductivity. The specific surface area of the active material (AC) can be adjusted in the above-described range by changing synthesis conditions, a particle diameter adjusting method (condition), or micronizing conditions.

The specific surface area of the conductive auxiliary agent (CA) is generally in a range of 0.1 to 400 m²/g. However, among the above, it is preferably in a range of 10 to 350 m²/g, more preferably in a range of 20 to 300 m²/g, still more preferably in a range of 30 to 250 m²/g, and particularly preferably 40 to 100 m² or less, from the viewpoint of ensuring the electron conductivity in the electrode. The specific surface area of the conductive auxiliary agent (CA) can be adjusted in the above-described range by changing synthesis conditions, a particle diameter adjusting method (condition), or micronizing conditions.

The specific surface area of each component is a value measured according to the following method.

In the present invention, the specific surface area means the BET specific surface area, and it is a value calculated according to the BET (one point) method by the nitrogen adsorption method. Specifically, it shall be a value measured under the following conditions using the following measuring device.

Specific surface area/micropore distribution measuring device: BELSORP MINI (product name, manufactured by MicrotracBEL Corp.) is used to carry out the measurement according to the gas adsorption method (nitrogen gas). 0.3 g of each component is packed in a sample tube having an inner diameter of 3.6 mm, and nitrogen is allowed to flow at 80° C. for 6 hours to dry the sample, which is used for the measurement. The measurement is carried out under the following measurement conditions.
Measurement temperature: −196° C.
Purge gas: Helium gas (He)
Adsorbing gas: Nitrogen gas (N₂)
Inner diameter of sample tube: 3.6 mm

The electrode composition according to the embodiment of the present invention is preferably a slurry in which an inorganic solid electrolyte, an active material, and a conductive auxiliary agent are dispersed in a dispersion medium, particularly a high-concentration slurry.

The concentration of solid contents of the electrode composition according to the embodiment of the present invention is not particularly limited and can be appropriately set to, for example, 20% to 80% by mass. The concentration of solid contents is preferably 30% to 70% by mass and more preferably 40 to 60% by mass.

Since the electrode composition according to the embodiment of the present invention exhibits excellent dispersion characteristics and excellent application suitability, it is possible to obtain a high-concentration composition (slurry) in which the concentration of solid contents is set to be high as compared in the related art as the electrode composition. For example, the lower limit value of the concentration of solid contents of the high-concentration composition can be set to 50% by mass or more. The upper limit value thereof is less than 100% by mass and can be set to, for example, 90% by mass or less. It is preferably 85% by mass or less and more preferably 80% by mass or less.

The viscosity of the electrode composition according to the embodiment of the present invention at 25° C. (room temperature) is not particularly limited. The viscosity at 25° C. is preferably 200 to 15,000 cP, more preferably 200 to 8,000 cP, and still more preferably 400 to 6,000 cP, in terms of improving the dispersion characteristics and application suitability.

The viscosity of the electrode composition can be appropriately set, for example, by changing or adjusting the concentration of solid contents thereof, the kind or content of the solid particle or the polymer binder, the kind of the dispersion medium, and the like, and furthermore, the dispersion conditions and the like.

—Measuring Method for Viscosity—

A value measured according to the following method is employed as the viscosity of the electrode composition.

Specifically, using an E-type viscometer (TV-35, manufactured by TOKI SANGYO Co., Ltd.) and a standard cone rotor (1°34′×R24), 1.1 mL of a sample (an electrode composition) is applied to a sample cup adjusted to 25° C., and the sample cup is set in the main body and maintained for 5 minutes until the temperature became constant. Thereafter, the measurement range is set to “U”, and a value obtained by measuring at a shear rate of 10 s⁻¹ (rotational speed: 2.5 rpm) one minute after the start of rotation is defined as the viscosity at 25° C.

It is preferable that the electrode composition according to the embodiment of the present invention contains the inorganic solid electrolyte (SE), the active material (AC), the conductive auxiliary agent (CA), the dispersion medium (D), and the polymer binder (B1) that is dissolved in the dispersion medium (D), and satisfies the following viscosity characteristics, from the viewpoint of further improving dispersion characteristics and application suitability. In particular, it is preferable that the electrode composition according to the embodiment of the present invention, which satisfies the above-described conditions (1) to (4), satisfies the following viscosity characteristics from the viewpoint of further improving dispersion characteristics and application suitability to a higher level.

—Viscosity Characteristics—

The viscosity characteristics mean that in a case where a viscosity at a shear rate of 10 s⁻¹ and a viscosity at a shear rate of 20 s⁻¹ are measured, and a power approximation expression is created in terms of orthogonal coordinates where a lateral axis indicates the shear rate and a vertical axis indicates the viscosity, an approximate value (a value represented by a reference numeral Ain (Expression PA) below) of the viscosity at a shear rate of 1 s⁻¹ is 5,000 cP or more, and an absolute value of the exponent part of the power approximation expression (a value represented by a reference numeral B in (Expression PA) below) is 0.6 or less.

Power approximation expression: y=A×x^{-B} (Expression PA)

In a case where the electrode composition according to the embodiment of the present invention exhibits the above-described viscosity characteristics, it is possible to increase the viscosity during the preparation of the electrode composition and concurrently it is possible to reduce the change in viscosity during the preparation of and during the application of the electrode composition, and thus it is possible to further improve dispersion characteristics and application suitability. From the viewpoint that the dispersion characteristics can be improved by increasing the viscosity during the preparation, the approximate value of the viscosity is preferably 1,000 cP or more, more preferably 2,000 cP or more, and still more preferably 5,000 cP or more. The upper limit thereof is not particularly limited; however, it is practically 100,000 cP or less, and it is preferably 80,000 cP or less, more preferably 75,000 cP or less, still more preferably 50,000 cP or less, and particularly preferably 20,000 cP or less. From the viewpoint that the change in viscosity during the preparation and application of the electrode composition is reduced, which provides not only excellent dispersion characteristics during the preparation but also excellent application suitability, the absolute value of the exponent part is preferably 1.0 or less, more preferably 0.6 or less, and still more preferably 0.55 or less. The lower limit thereof is not particularly limited; however, it is practically 0.05 or more, and it is preferably 0.1 or more, more preferably 0.15 or more, and still more preferably 0.2 or more.

—Determination Method for Approximate Value of Viscosity and Absolute Value of Exponent Part—

First, the viscosity at each of the shear rates is measured to create a power approximation expression.

The viscosity at a shear rate of 10 s⁻¹ has the same meaning as the viscosity at 25° C., and it shall be a value measured according to the above-described measuring method for viscosity. On the other hand, the viscosity at a shear rate of 20 s⁻¹ shall be a value measured according to the above-described measuring method for a viscosity except that the shear rate is changed to 20 s⁻¹. The viscosity at each shear rate obtained in this way is plotted on orthogonal coordinates where the lateral axis indicates the shear rate and the vertical axis indicates the viscosity, and a power approximation expression is determined for a curve connecting the two points.

Next, an approximate value of the viscosity at a shear rate of 1 s⁻¹ in this power approximation expression is determined and taken as “the approximate value of the viscosity” described above. On the other hand, the exponent part of the power approximation expression is read, and the absolute value thereof is taken as “the absolute value of the exponent part”.

The electrode composition according to the embodiment of the present invention is preferably a non-aqueous composition. In the present invention, the non-aqueous composition includes not only an aspect including no watery moisture but also an aspect where the moisture content (also referred to as the “watery moisture content”) is preferably 500 ppm or less. In the non-aqueous composition, the moisture content is more preferably 200 ppm or less, still more preferably 100 ppm or less, and particularly preferably 50 ppm or less. In a case where the electrode composition is a non-aqueous composition, it is possible to suppress the deterioration of the inorganic solid electrolyte. The water content refers to the amount of water (the mass proportion thereof to the electrode composition) in the electrode composition and specifically is a value measured by Karl Fischer titration after filtering the solid electrolyte composition through a membrane filter having a pore size of 0.02 μm.

Due to having excellent characteristics described above, the electrode composition according to the embodiment of the present invention can be preferably used as a material that forms an active material layer that is used for an electrode sheet for an all-solid state secondary battery and an all-solid state secondary battery. In particular, it can be preferably used as a material that forms a positive electrode active material layer or a material that forms a negative electrode active material layer containing a negative electrode active material having a large expansion and contraction due to charging and discharging.

Hereinafter, the components that are included in the electrode composition according to the embodiment of the present invention and components that may be included therein will be described.

<Inorganic Solid Electrolyte (SE)>

The electrode composition of the embodiment of the present invention contains the sulfide-based inorganic solid electrolyte (SE).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte contained in the electrode composition according to the embodiment of the present invention, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

In a case where the all-solid state secondary battery according to the embodiment of the present invention is a lithium ion battery, the inorganic solid electrolyte preferably has a lithium ion conductivity.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (S1).

Lₐ₁M_{b1}P_{c1}S_{d1}A_{c1} (S1)

In Formula (S1), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S5)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—Ge_{S}2-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—Si_{S}2-P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms); Li_{xF}Si_{yf}o_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure. In addition, a phosphorus compound containing Li, P, or O is also desirable.

Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In the case where the inorganic solid electrolyte has a particle shape, the particle diameter (volume average particle diameter) of the inorganic solid electrolyte is not particularly limited; however, it is preferably 0.01 μm or more, more preferably 0.1 μm or more, and still more preferably 0.5 μm or more. The upper limit thereof is preferably 100 μm or less, more preferably 50 μm or less, and still more preferably 10 μm or less.

The particle diameter of the inorganic solid electrolyte is measured according to the following procedure. Using water (heptane in a case where the inorganic solid electrolyte is unstable in water), the particles of the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced and measured, and the average values thereof are employed.

The method of adjusting the average particle diameter is not particularly limited, and a known method can be applied. Examples thereof include a method using a normal pulverizer or a classifier. As the pulverizer or a classifier, for example, a mortar, a ball mill, a sand mill, a vibration ball mill, a satellite ball mill, a planetary ball mill, a swirling airflow-type jet mill, or a sieve is suitably used. During pulverization, it is possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

The inorganic solid electrolyte contained in the electrode composition may be one kind or two or more kinds.

The content of the inorganic solid electrolyte in the electrode composition is not particularly limited and appropriately determined in consideration of the specific surface area and the like of the electrode forming mixture. From the viewpoint of dispersion characteristics and application suitability, it is preferably 50% by mass or more, more preferably 70% by mass or more, and particularly preferably 90% by mass or more, in 100% by mass of the solid content in terms of the total with the active material. From the same viewpoint, the upper limit thereof is preferably 99.9% by mass or less, more preferably 99.5% by mass or less, and particularly preferably 99% by mass or less.

<Active Material (AC)>

The electrode composition according to the embodiment of the present invention contains an active material capable of intercalating and deintercalating ions of a metal belonging to Group 1 or Group 2 in the periodic table.

Examples of such active materials include a positive electrode active material and a negative electrode active material, which will be described later.

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide, an organic substance, or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The positive electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the positive electrode active material has a particle shape, the particle diameter (volume average particle diameter) of the positive electrode active material is not particularly limited; however, it is, for example, preferably 0.1 to 50 μm and more preferably 0.5 to 10 μm. The particle diameter of the positive electrode active material particle can be adjusted in the same manner as in the particle diameter of the inorganic solid electrolyte, and the particle diameter thereof can be measured by the same measuring method as in the average particle diameter of the inorganic solid electrolyte.

A positive electrode active material obtained using a baking method may be used after being washed with water, an acidic aqueous solution, an alkaline aqueous solution, or an organic solvent.

The positive electrode active material contained in the electrode composition of the present invention may be one kind or two or more kinds.

The content of the positive electrode active material in the electrode composition is not particularly limited and is appropriately determined in consideration of the specific surface area of the electrode forming mixture, the battery capacity, and the like. For example, it is preferably 10% to 97% by mass, more preferably 30% to 95% by mass, still more preferably 40% to 93% by mass, and particularly preferably 50% to 90% by mass in 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S₆₂-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 20 value in case of being measured by an X-ray diffraction method using CuKα rays, and the oxide may have a crystalline diffraction line. The highest intensity in a crystalline diffraction line observed in a range of 400 to 700 in terms of 20 value is preferably 100 times or less and more preferably 5 times or less with respect to the intensity of a diffraction line at the apex in a broad scattering band observed in a range of 200 to 400 in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume change during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon element-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including the silicon element and the tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The negative electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the negative electrode active material has a particle shape, the particle diameter (volume average particle diameter) of the negative electrode active material is not particularly limited; however, it is, for example, preferably 0.1 to 60 μm and more preferably 0.5 to 10 μm. The particle diameter of the negative electrode active material particle can be adjusted in the same manner as in the particle diameter of the inorganic solid electrolyte, and the particle diameter thereof can be measured by the same measuring method as in the average particle diameter of the inorganic solid electrolyte.

The negative electrode active material contained in the electrode composition according to the embodiment of the present invention may be one kind or two or more kinds.

The content of the negative electrode active material in the electrode composition is not particularly limited and is appropriately determined in consideration of the specific surface area of the electrode forming mixture, the battery capacity, and the like. For example, it is preferably 10% to 90% by mass, more preferably 20% to 85% by mass, still more preferably 30% to 80% by mass, and even still more preferably 40% to 75% by mass in 100% by mass of the solid content.

The chemical formulae of the compounds obtained by the above baking method can be calculated using an inductively coupled plasma (ICP) emission spectroscopy as a measuring method from the mass difference of powder before and after baking as a convenient method.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent (CA)>

The electrode composition according to the embodiment of the present invention contains a conductive auxiliary agent.

The conductive auxiliary agent is not particularly limited, and a conductive auxiliary agent that is known as an ordinary conductive auxiliary agent can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The conductive auxiliary agent contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the conductive auxiliary agent has a particle shape, the particle diameter (volume average particle diameter) of the conductive auxiliary agent is not particularly limited; however, it is, for example, preferably 0.02 to 1.0 μm and more preferably 0.03 to 0.5 μm. The particle diameter of the conductive auxiliary agent can be adjusted in the same manner as in the particle diameter of the inorganic solid electrolyte, and the particle diameter thereof can be measured by the same measuring method as in the average particle diameter of the inorganic solid electrolyte.

The conductive auxiliary agent contained in the electrode composition according to the embodiment of the present invention may be one kind or two or more kinds.

The content of the conductive auxiliary agent in the electrode composition is not particularly limited and is appropriately determined in consideration of the specific surface area of the electrode forming mixture, the battery capacity, and the like. For example, in 100% by mass of the solid content, it is preferably more than 0% by mass and 10% by mass or less and more preferably 1.0% to 5.0% by mass.

<Polymer Binder (B)>

The electrode composition according to the embodiment of the present invention contains the polymer binder (B) containing one or more kinds of polymer binders (dissolved type binders) (B1) that are soluble in the dispersion medium (D) contained in this composition. The polymer binder (B) contained in the electrode composition according to the embodiment of the present invention may contain one or two or more kinds of polymer binders other than the dissolved type binder (B1), for example, polymer binders (non-dissolved type binders) and the like that are insoluble (generally present in a particle shape) in the dispersion medium contained in the electrode composition. The non-dissolved type binder is preferably a polymer binder (a particulate binder) that is present in a particle shape in the electrode composition.

(Dissolved Type Binder (B1))

As described above, the dissolved type binder (B1) is not particularly limited as long as it is composed of a polymer soluble in the dispersion medium contained in the electrode composition. In a case of using this binder in combination with the inorganic solid electrolyte, the active material, and the conductive auxiliary agent in the electrode composition according to the embodiment of the present invention, it is possible to improve the dispersion characteristics and the application suitability of the electrode composition (slurry).

(Preferred Physical Properties or Characteristics of Polymer (b1))

The polymer (b1) constituting the dissolved type binder is not particularly limited as long as it is a polymer having characteristics or physical properties that satisfy the mass average molecular weight described in the Condition (1) and the value of polarity element of the surface energy described in the Condition (2), which are appropriately set.

Preferred characteristics or physical properties of the polymer (b1) will be described.

In terms of improving affinity with the dispersion medium and dispersion stability of the solid particles, the SP value of the polymer (b1) is, for example, preferably 10 to 24 MPa^{1/2}, more preferably 14 to 22 MPa^{1/2}, and still more preferably 16 to 20 MPa^{1/2}.

A calculation method for an SP value will be described.

(1) The SP Value of the Constitutional Unit is Calculated.

First, in the polymer (b1), a constitutional unit of which the SP value is specified is determined.

For example, in a case where the SP value of the polymer (b1) is calculated, a constitutional unit that is the same as that of the constitutional component derived from the raw material compound is adopted in a case where the polymer is adopted as a chain polymerization polymer.

Next, the SP value for each constitutional unit is determined according to the Hoy method unless otherwise specified (see Table 5, Table 6, and the following expressions in Table 6 in H. L. Hoy JOURNAL OF PAINT TECHNOLOGY, Vol. 42, No. 541, 1970, 76-118, and POLYMER HANDBOOK 4^{th}, Chapter 59, VII, page 686).

$${δ}_{t} = \frac{{F}_{t} + \frac{B}{\overline{n}}}{V} ; B = 277$$

In the expression, δₜ indicates an SP value. Fₜ is a molar attraction function (J×cm³)^{1/2}/mol and represented by the following expression. V is a molar volume (cm³/mol) and represented by the following expression. n̅ is represented by the following expression.

$${F}_{t} = \sum {n}_{i} {F}_{t , i}$$

$$V = \sum {n}_{i} {V}_{i}$$

$$\overline{n} = \frac{0.5}{{Δ}_{T}^{( P )}}$$

$${Δ}_{T}^{( P )} = \sum {n}_{i} {Δ}_{T , i}^{( P )}$$

In the above formula, F_{t,i} indicates a molar attraction function of each constitutional unit, Vᵢ indicates a molar volume of each constitutional unit, Δ^{(P)}_{T,i} indicates a correction value of each constitutional unit, and nᵢ indicates the number of each constitutional unit.

(2) SP Value of Polymer (b1)

The SP value of the polymer (b1) is calculated from the following expression using the constitutional unit determined as described above and the determined SP value. It is noted that the SP value of the constitutional unit determined according to the above document is converted into an SP value (unit: MPa^{1/2}) (for example, 1 cal^{1/2}cm^{-3/2}≈2.05 J^{1/2}cm^{-3/2}≈2.05 MPa^{1/2}) and used.

SPₚ²=(SP₁²×W₁)+(SP₂²×W₂)+ . . .

In the expression, SP₁, SP₂ . . . indicates the SP values of the constitutional units, and W₁, W₂ . . . indicates the mass fractions of the constitutional units.

In the present invention, the mass fraction of a constitutional unit shall be a mass fraction of the constitutional component (the raw material compound from which this constitutional component is derived) in the polymer, corresponding to the constitutional unit.

The SP value of the polymer (b1) can be adjusted depending on the kind or the composition (the kind and the content of the constitutional component) of the polymer (b1).

It is preferable that the polymer (b1) has an SP value that satisfies a difference (in terms of absolute value) in SP value in a range described later with respect to the SP value of the dispersion medium from the viewpoint of achieving higher dispersion characteristics.

The watery moisture concentration of the polymer (b1) is preferably 100 ppm (in terms of mass) or lower. In addition, as this polymer, a polymer may be crystallized and dried, or a polymer solution may be used as it is.

The polymer (b1) is preferably noncrystalline. In the present invention, the description that a polymer is “noncrystalline” typically refers to that no endothermic peak due to crystal melting is observed when the measurement is carried out at the glass transition temperature.

The polymer (b1) may be a non-crosslinked polymer or a crosslinked polymer. In addition, in a case where the crosslinking of the polymer (b1) proceeds by heating or application of a voltage, it is preferable that the polymer (b1) before crosslinking has a mass average molecular weight in a range defined in the above-described condition (1), and it is preferable that the polymer (b1) at the start of use of the all-solid state secondary battery also has a mass average molecular weight in a range defined in the above-described condition (1).

The kind, composition, and the like of the polymer (b1) are not particularly limited as long as the polymer (b1) is a polymer having characteristics or physical properties that satisfy the above-described condition (1) and condition (2), and it is possible to use various polymers as polymers for a binder for an all-solid state secondary battery.

It is preferable that the polymer (b1) does not react with the inorganic solid electrolyte due to the heating step in the preparation of the electrode composition, the production of the electrode sheet for an all-solid state secondary battery, or the manufacturing of the all-solid state secondary battery, from the viewpoint that the deterioration of the dispersion characteristics, the application suitability, and the battery characteristics can be suppressed. Specifically, it is preferable that the polymer (b1) does not have an ethylenic double bond. In the present invention, the fact that a polymer does not have an ethylenic double bond in the molecule includes an aspect in which a polymer has an ethylenic double bond within a range where the effect of the present invention is not impaired, for example, an abundance in the molecule (according to the nuclear magnetic resonance (NMR) spectroscopy method) is 0.1% or less.

Preferred examples of the polymer (b1) include a polymer having, in the main chain, at least one bond selected from a urethane bond, a urea bond, an amide bond, an imide bond, and an ester bond, or a polymerized chain of carbon-carbon double bonds. More specifically, examples of the polymer having, among the above bonds, a urethane bond, a urea bond, an amide bond, an imide bond, or an ester bond in the main chain include sequential polymerization (polycondensation, polyaddition, or addition condensation) polymers such as polyurethane, polyurea, polyamide, polyimide, and polyester. In addition, examples of the polymer having a polymerized chain of carbon-carbon double bonds in the main chain include chain polymerization polymers such as a fluoropolymer (a fluorine-containing polymer), a hydrocarbon polymer, a vinyl polymer, and a (meth)acrylic polymer. The polymerization mode of these polymers is not particularly limited, and the chain polymerization polymer may be any one of a block copolymer, an alternating copolymer, or a random copolymer. Among them, a chain polymerization polymer is preferable, a hydrocarbon polymer, a vinyl polymer, or a (meth)acrylic polymer is more preferable, and a (meth)acrylic polymer is still more preferable.

The polymer (b1) constituting the binder (B1) may be one kind or two or more kinds. In a case where the binder (B1) is composed of two or more kinds of polymers, it is preferable that at least one kind of polymer is a chain polymerization polymer, and it is more preferable that all the polymers are chain polymerization polymers.

In the present invention, a main chain of the polymer refers to a linear molecular chain in which all the molecular chains that constitute the polymer other than the main chain can be conceived as a branched chain or a pendant group with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain.

(Constitutional Component Having Substituent Having 8 or More Carbon Atoms as Side Chain)

The polymer (b1) preferably contains a constitutional component having a substituent having 8 or more carbon atoms as a side chain. In a case where the binder (B1) is composed of two or more kinds of polymers (b1), it is preferable that at least one kind of polymer contains the above-described constitutional component, and an aspect in which all the polymers contain the above-described constitutional component is also one of the preferred aspects. This constitutional component reduces the polarity (SP value) of the polymer (b1) and increases the solubility in a dispersion medium, thereby contributing to the improvement of the application suitability, particularly the improvement of the dispersion characteristics.

This constitutional component may be any constitutional component that forms the polymer (b1), and a substituent thereof having 8 or more carbon atoms is introduced as a side chain of the polymer (b1) or a part thereof. This constitutional component has a substituent having 8 or more carbon atoms, directly or through a linking group in a partial structure that is incorporated into the main chain of the polymer (b1).

The partial structure that is incorporated into the main chain of the polymer is appropriately selected depending on the kind of the polymer and the like, and examples thereof include a carbon chain (a carbon-carbon bond) in a case where the polymer (b1) is a chain polymerization polymer.

The substituent having 8 or more carbon atoms is not particularly limited, and examples thereof include a group having 8 or more carbon atoms among the substituent Z, which will be described later. In a case where the constitutional component includes a polymerized chain as a side chain, the substituent having 8 or more carbon atoms includes a substituent having 8 or more carbon atoms contained in each constitutional component constituting this polymerized chain; however, it shall not be allowed to regard the entire polymerized chain as a substituent and regard it as a substituent having 8 or more carbon atoms.

Specific examples of the substituent having 8 or more carbon atoms include a long-chain alkyl group having 8 or more carbon atoms, a cycloalkyl group having 8 or more carbon atoms, an aryl group having 8 or more carbon atoms, and an aralkyl group having 8 or more carbon atoms, where a long-chain alkyl group having 8 or more carbon atoms is preferable.

The number of carbon atoms of this substituent may be any number as long as it is 8 or more, and it is preferably 10 or more and more preferably 12 or more. The upper limit thereof is not particularly limited, and it is preferably 24 or less, more preferably 20 or less, and still more preferably 16 or less. The number of carbon atoms of the substituent indicates the number of carbon atoms constituting this substituent, and in a case where this substituent further has a substituent, the number of carbon atoms constituting the substituent that is further contained is included for calculation.

The linking group is not particularly limited; however, examples thereof include an alkylene group (preferably having 1 to 12 carbon atoms, more preferably 1 to 6 carbon atoms, and still more preferably having 1 to 3 carbon atoms), an alkenylene group (having 2 to 6 carbon atoms and more preferably having 2 or 3 carbon atoms), an arylene group (having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. The linking group is preferably a group obtained by combining an alkylene group, an arylene group, a carbonyl group, an oxygen atom, a sulfur atom, and an imino group, more preferably a group obtained by combining an alkylene group, an arylene group, a carbonyl group, an oxygen atom, and an imino group, still more preferably a group containing a —CO—O— group, a —CO—N(R^{N})— group (here, R^{N} is as described above), particularly preferably a —CO—O— group or a —CO—N(R^{N})— group (here, R^{N} is as described above), and most preferably a —CO—O— group. The number of atoms that constitute the linking group and the number of linking atoms are as described below.

In the present invention, the number of atoms that constitute the linking group is preferably 1 to 36, more preferably 1 to 24, still more preferably 1 to 12, and particularly preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in a case of —C(═O)—O—, the number of atoms that constitute the linking group is 3; however, the number of linking atoms is 2.

Each of the partial structure, the linking group, and the substituent having 8 or more carbon atoms, which are incorporated into the main chain, may have a substituent. Such a substituent is not particularly limited, and examples thereof include a group selected from the substituent Z described later, where a group other than the functional group selected from the group (a) of functional groups is preferable.

The constitutional component having a substituent having 8 or more carbon atoms can be constituted by appropriately combining the above-described partial structure incorporated into the main chain, a substituent having 8 or more carbon atoms, and a linking group, and it is, for example, preferably a constitutional component represented by Formula (1-1).

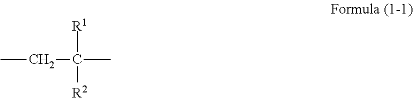

In Formula (1-1), R¹ represents a hydrogen atom or an alkyl group (preferably having 1 to 12 carbon atoms, more preferably 1 to 6 carbon atoms, and still more preferably 1 to 3 carbon atoms). The alkyl group that can be adopted as R¹ may have a substituent. The substituent is not particularly limited; however, examples thereof include the substituent Z described above. A group other than the functional group selected from the group (a) of functional groups is preferable, and suitable examples thereof include a halogen atom.

R² represents a group having a substituent having 8 or more carbon atoms. In the present invention, the group having a substituent includes a group consisting of the substituent itself (where the substituent is directly bonded to the carbon atom in the above formula, to which R¹ is bonded) and a group consisting of a linking group (where a substituent is bonded to the carbon atom in the above formula via a linking group, to which R¹ is bonded) that links the carbon atom in the above formula, to which R² is bonded, to a substituent.

The substituent having 8 or more carbon atoms contained in R² and the linking group which may be contained in R² are as described above. R² is particularly preferably a long-chain alkyl group having 8 or more carbon atoms on the right side of —C(═O)—O—.

In Formula (1-1), the carbon atom adjacent to the carbon atom to which R¹ is bonded has two hydrogen atoms; however, in the present invention, it may have one or two substituents. The substituent is not particularly limited; however, examples thereof include a substituent Z described later, and a group other than the functional group selected from the Group (a) of functional groups is preferable.

It is preferable that the constitutional component having a substituent having 8 or more carbon atoms is, for example, a constitutional component derived from a compound having a substituent having 8 or more carbon atoms among the (meth)acrylic compounds (M1) described later, or a constitutional component derived from a compound having a substituent having 8 or more carbon atoms among other polymerizable compounds (M2) described later, where a long-chain alkyl ester compound of a (meth)acrylic acid (having 8 or more carbon atoms) is preferable.

Specific examples of the constitutional component having a substituent having 8 or more carbon atoms include the constitutional components in the polymers synthesized in Examples; however, the present invention is not limited thereto.

The content of the constitutional component having a substituent having 8 or more carbon atoms in the polymer (b1) is not particularly limited and is selected from a range of 0 to 100% by mole. For example, in terms of the dispersion characteristics of the binder (B1), it is preferably 20% to 99.9% by mole, more preferably 30% to 99.5% by mole, still more preferably 30% to 99% by mole, particularly preferably 50% to 98% by mole, and most preferably 80% to 96% by mole.

The content defined in the present specification can be set in a range obtained by appropriately combining the upper limit value and the lower limit value of each range.

(Constitutional Component Having Functional Group Selected from Group (a) of Functional Groups)

The polymer (b1) preferably contains a constitutional component having a functional group selected from the following group (a) of functional groups. In a case where the binder (B1) is composed of two or more kinds of polymers (b1), it is preferable that at least one kind of polymer contains the above-described constitutional component having a functional group described above, and an aspect in which all the polymers contain the above-described constitutional component having a functional group described above is also one of the preferred aspects. This constitutional component improves the adsorptive force of the binder (B1) with respect to the inorganic solid electrolyte, the active material, and the conductive auxiliary agent, thereby contributing to the improvement of the dispersion characteristics and the adhesiveness.

This constitutional component may be any component that forms the polymer (b1). The functional group may be incorporated into the main chain or the side chain of the polymer. In the case of being incorporated into the side chain, the functional group may be directly bonded to the main chain or may be bonded through the above-described linking group.

In the chain polymerization polymer, the constitutional component having an ester bond (excluding an ester bond that forms a carboxy group) or an amide bond means a constitutional component in which an ester bond or an amide bond is not directly bonded to an atom that constitutes the main chain of a chain polymerization polymer and an atom that constitutes the main chain of a polymerized chain (for example, a polymerized chain contained in a macromonomer) that is incorporated into the chain polymerization polymer as a branched chain or a pendant chain, and it does not include, for example, a constitutional component derived from a (meth)acrylic acid alkyl ester.

The functional group contained in one constitutional component may be one kind or two or more kinds, and in a case where two or more kinds are contained, they may be or may not be bonded to each other.

<Group (a) of Functional Groups>

A hydroxy group, an amino group, a carboxy group, a sulfo group, a phosphate group, a phosphonate group, a sulfanyl group, an ether bond (—O—), an imino group (═NR, or —NR—), an ester bond (—CO—O—), an amide bond (—CO—NR—), a urethane bond (—NR—CO—O—), a urea bond (—NR—CO—NR—), a heterocyclic group, an aryl group, a carboxylic acid anhydride group, and a fluoroalkyl group

Each of the amino group, the sulfo group, the phosphate group (the phosphoryl group), the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. The phosphonate group is not particularly limited; however, examples thereof include a phosphonate group having 0 to 20 carbon atoms. In a case where a ring structure contains an amino group, an ether bond, an imino group (—NR—), an ester bond, an amide bond, a urethane bond, a urea bond, or the like, it is classified as a heterocycle. The hydroxy group, the amino group, the carboxy group, the sulfo group, the phosphate group, the phosphonate group, or the sulfanyl group may form a salt.

The fluoroalkyl group is a group obtained by substituting at least one hydrogen atom of an alkyl group or cycloalkyl group with a fluorine atom, and it preferably has 1 to 20 carbon atoms, more preferably 2 to 15 carbon atoms, and still more preferably 3 to 10 carbon atoms. Regarding the number of fluorine atoms on the carbon atom, a part of the hydrogen atoms may be substituted, or all the hydrogen atoms may be substituted (a perfluoroalkyl group).

R in each bond represents a hydrogen atom or a substituent, and it is preferably a hydrogen atom. The substituent is not particularly limited. It is selected from a substituent Z described later, and an alkyl group is preferable.

The carboxylic acid anhydride group is not particularly limited; however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. The carboxylic acid anhydride group derived from a cyclic carboxylic acid anhydride also corresponds to a heterocyclic group; however, it is classified as a carboxylic acid anhydride group in the present invention. Examples thereof include acyclic carboxylic acid anhydrides such as acetic acid anhydride, propionic acid anhydride, and benzoic acid anhydride, and cyclic carboxylic acid anhydrides such as maleic acid anhydride, phthalic acid anhydride, fumaric acid anhydride, and succinic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride is preferable. Specific examples thereof include maleic acid anhydride.

Examples of the carboxylic acid anhydride group include a group represented by Formula (2a) and a constitutional component represented by Formula (2b); however, the present invention is not limited thereto. In each of the formulae, * represents a bonding position.

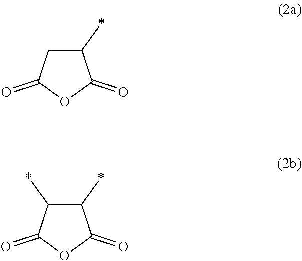 [SMILES: *C1CC(=O)OC1=O ; *C1C(=O)OC(=O)C1*]

The linking group that bonds a functional group to the main chain is not particularly limited, and examples thereof include the linking group described above. A particularly preferred linking group is a group obtained by combining a —CO—O— group or a —CO—N(R^{N})— group (R^{N} is as described above) and an alkylene group.

A method of incorporating a functional group into a polymerized chain will be described later.

The compound having the above-described functional group is not particularly limited; however, examples thereof include a compound having at least one carbon-carbon unsaturated bond and at least one functional group described above. For example, it includes a compound in which a carbon-carbon unsaturated bond and the above-described functional group are directly bonded, a compound in which a carbon-carbon unsaturated bond and the above-described functional group are bonded through a linking group, as well as a compound (for example, the polymerizable cyclic carboxylic acid anhydride) in which the functional group itself contains a carbon-carbon unsaturated bond. Further, the compound having the above-described functional group include compounds that are capable of introducing a functional group into the polymer constitutional component after polymerization by various reactions (for example, alcohol and each of the amino, mercapto, and epoxy compounds (including polymers thereof), which are capable of undergoing an addition reaction or condensation reaction with a constitutional component derived from carboxylic acid anhydride, a constitutional component having a carbon-carbon unsaturated bond, or the like). Further, examples of the compound having the above-described functional group also include a compound in which a carbon-carbon unsaturated bond is bonded directly or through a linking group to a macromonomer having a functional group incorporated as a substituent in the polymerized chain. Examples of the macromonomer from which a macromonomer constitutional component is derived include a macromonomer having a polymerized chain of a chain polymerization polymer described later. The number average molecular weight of the macromonomer is not particularly limited; however, it is preferably 500 to 100,000, more preferably 1,000 to 50,000, and still more preferably 2,000 to 20,000, in that the binding force of solid particles as well as the adhesiveness to the collector can be further strengthened while maintaining excellent dispersion characteristics and excellent application suitability. The content of the repeating unit having a functional group that is incorporated into the macromonomer is preferably 1% to 100% by mole, more preferably 3% to 80% by mole, and still more preferably 5% to 70% by mole. The content of the repeating unit having no functional group is preferably 0%% to 90% by mole, more preferably 0% to 70% by mole, and still more preferably 0% to 50% by mole. Any component can be selected from the viewpoint of solubility.

The above-described constitutional component having a functional group is not particularly limited as long as it has the above-described functional group; however, examples thereof include a constitutional component obtained by introducing the above-described functional group into a (meth)acrylic compound (M1) or another polymerizable compound (M2) described later, a constitutional component represented by any one of Formulae (b-1) to (b-3), or a constitutional component represented by Formulae (1-1) described later.

The compound from which the above-described constitutional component having a functional group is derived is not particularly limited; however, examples thereof include a polymerizable cyclic carboxylic acid anhydride and a compound in which the above-described functional group is introduced into a fluoroalkyl group-containing (meth)acrylic acid short-chain alkyl ester compound (here, short-chain alkyl means an alkyl group having 3 or less of carbon atoms). It is noted that the compound obtained by introducing the above-described functional group into a polymerizable cyclic carboxylic acid anhydride is as described above, and example thereof include a dicarboxylic acid monoester compound that is obtained by subjecting a maleic acid anhydride compound and an alcohol to an addition reaction (a ring-opening reaction).

The content of the above-described constitutional component having a functional group, in the polymer, is preferably 0.01% to 50% by mole, more preferably 0.01% to 30% by mole, still more preferably 0.1% to 10% by mole, and particularly preferably 0.5% to 10% by mole, in terms of the dispersion characteristics and binding property of the binder (B1).

In a case where the polymer (b1) has a plurality of constitutional components having a functional group, the content of the constitutional components having a functional group is adopted as the total amount. In addition, in a case where one constitutional component has a plurality of functional groups or a plurality of kinds of functional groups, the content of this constitutional component having functional groups is generally employed as the content of the constitutional component.

In a case where two or more kinds of polymer binders are contained, the content of the above-described constitutional component having a functional group with respect to the total number of moles of the constitutional components of the polymers that form all the polymer binders is not particularly limited, and it is appropriately set according to the content in each of the above polymers.

(Another Constitutional Component)

The polymer (b1) may contain a constitutional component (referred to as another constitutional component) other than the constitutional component having a substituent having 8 or more carbon atoms and the constitutional component having a functional group selected from the group (a) of functional groups. The other constitutional component is not particularly limited as long as it can constitute the polymer (b1) and can be appropriately selected depending on the kind of the polymer (b1). Examples thereof include a constitutional component derived from a compound that does not have a substituent having 8 or more carbon atoms and the above-described functional group, among the (meth)acrylic compound (M1) and the other polymerizable compound (M2) described later.

The content of the other constitutional component in the polymer (b1) is not particularly limited and is appropriately determined from a range of 0% to 100% by mole in consideration of the contents of the above-described constitutional components. It is, for example, preferably 1% to 99% by mole, more preferably 5% to 80% by mole, and still more preferably 8% to 60% by mole, in a case where the polymer (b1) contains the other constitutional component.

Hereinafter, a chain polymerization polymer suitable for the present invention will be specifically described.

(Hydrocarbon Polymer)

Examples of the hydrocarbon polymer include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

It is also preferable that the hydrocarbon polymer contains, in addition to constitutional component (for example, styrene) constituting the hydrocarbon polymer described above, the above-described constitutional component having a substituent having 8 or more carbon atoms and the above-described constitutional component having a functional group, and examples of the constitutional component include a constitutional component derived from a polymerizable cyclic carboxylic acid anhydride such as maleic acid anhydride. Further, the constitutional component having a functional group also includes, for example, a constitutional component obtained by introducing a functional group selected from the above-described group (a) of functional groups described later or the like by various reactions into the copolymerized constitutional component.

The content of the constitutional component in the hydrocarbon polymer is not particularly limited, and it is appropriately selected in consideration of the condition (2), the physical properties, and the like. For example, it can be set in the following range.

The content of the constitutional component having a substituent having 8 or more carbon atoms in all the constitutional components constituting the hydrocarbon polymer is as described above.

In all the constitutional components constituting the hydrocarbon polymer, the content of the constitutional component derived from a compound having a functional group selected from the above-described group (a) of functional groups is, regardless of the above-described range, preferably 0.01% by mole or more, more preferably 0.02% by mole or more, still more preferably 0.05% by mole or more, and particularly preferably 0.1% by mole or more. The upper limit value thereof is preferably 10% by mole or less, more preferably 8% by mole or less, and still more preferably 5% by mole or less in all the constitutional components constituting the hydrocarbon polymer. In a case where the hydrocarbon polymer has a plurality of constitutional components having a functional group, the content of the constitutional components having a functional group shall be adopted as the total amount.

(Vinyl Polymer)

Examples of the vinyl polymer include a polymer containing a vinyl-based monomer other than the (meth)acrylic compound (M1), where the content of the vinyl polymer is, for example, 50% by mole or more. Examples of the vinyl-based monomer include vinyl compounds described later. Specific examples of the vinyl polymer include polyvinyl alcohol, polyvinyl acetal, polyvinyl acetate, and a copolymer containing these.

It is also preferable that this vinyl polymer has, in addition to the constitutional component derived from the vinyl-based monomer, the above-described constitutional component having a substituent having 8 or more carbon atoms, the above-described constitutional component having a functional group, and furthermore, at least one of a constitutional component derived from a (meth)acrylic compound (M1) that forms a (meth)acrylic polymer described later.

The content of the constitutional component in the vinyl polymer is not particularly limited, and it is appropriately selected in consideration of the condition (2), the physical properties, and the like. For example, it can be set in the following range.

The content of the constitutional component derived from a vinyl-based monomer in all the constitutional components constituting the vinyl polymer is preferably the same as the content of the constitutional component derived from the (meth)acrylic compound (M1) in the (meth)acrylic polymer. Here, in a case where the constitutional component having a substituent having 8 or more carbon atoms and the constitutional component having a functional group are a constitutional component derived from a vinyl-based monomer, the contents of the constitutional components are included for calculation in the content of the constitutional component derived from a vinyl-based monomer.

Each of the content of the above-described constitutional component having a substituent having 8 or more carbon atoms and the content of the above-described constitutional component having a functional group in all the constitutional components constituting the vinyl polymer are as described above.

The content of the constitutional component derived from the (meth)acrylic compound (M1) in the polymer is not particularly limited as long as it is less than 50% by mole; however, it is preferably 0% to 30% by mole.

((Meth)Acrylic Polymer)

The (meth)acrylic polymer is preferably a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound, and is also preferably a polymer having a constitutional component derived from this (meth)acrylic compound (M1) and at least one of a constitutional component having a substituent having 8 or more carbon atoms or a constitutional component having a functional group. In addition, a polymer containing a constitutional component derived from the other polymerizable compound (M2) is also preferable.

Examples of the (meth)acrylic acid ester compound include a (meth)acrylic acid alkyl ester compound, a (meth)acrylic acid aryl ester compound, a (meth)acrylic acid ester compound having a heterocyclic group, and a (meth)acrylic acid ester compound having a polymerized chain, where a (meth)acrylic acid alkyl ester compound is preferable. The number of carbon atoms of the alkyl group that constitutes the (meth)acrylic acid alkyl ester compound is not particularly limited; however, it can be set to, for example, 1 to 24, and it is preferably 3 to 20, more preferably 4 to 16, and still more preferably 8 to 14, in terms of dispersibility and adhesiveness. The number of carbon atoms of the aryl group that constitutes the aryl ester is not particularly limited; however, it can be set to, for example, 6 to 24, and it is preferably 6 to 10 and more preferably 6. In the (meth)acrylamide compound, the nitrogen atom of the amide group may be substituted with an alkyl group or an aryl group. The polymerized chain contained in the (meth)acrylic acid ester compound is not particularly limited; however, it is preferably an alkylene oxide polymerized chain and more preferably a polymerized chain consisting of an alkylene oxide having 2 to 4 carbon atoms. The degree of polymerization of the polymerized chain is not particularly limited and is appropriately set. An alkyl group or an aryl group is generally bonded to the end part of the polymerized chain.

The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include the “vinyl-based monomer” disclosed in JP2015-88486A.

The (meth)acrylic compound (M1) and the other polymerizable compound (M2) may have a substituent. The substituent is not particularly limited, and examples thereof preferably include a group selected from the substituent Z described later.

The content of the constitutional component in the (meth)acrylic polymer is not particularly limited, and it is appropriately selected in consideration of the condition (2), the physical properties, and the like. For example, it can be set in the following range.

The content of the constitutional component derived from the (meth)acrylic compound (M1) in all the constitutional components constituting the (meth)acrylic polymer is not particularly limited and is appropriately set in a range of 0% to 100% by mole. The upper limit thereof can be also set to, for example, 90% by mole. Here, in a case where the constitutional component having a substituent having 8 or more carbon atoms and the constitutional component having a functional group are a constitutional component derived from the (meth)acrylic compound (M1), the contents of the constitutional components are included for calculation in the content of the constitutional component derived from a vinyl-based monomer.

Each of the content of the above-described constitutional component having a substituent having 8 or more carbon atoms and the contents of the above-described constitutional component having a functional group and the other constitutional component in all the constitutional components constituting the (meth)acrylic polymer is as described above.

The content of the other polymerizable compound (M2) in all the constitutional components constituting the (meth)acrylic polymer is not particularly limited; however, it can be set to, for example, less than 50 mol %, and it is preferably 1% to 30% by mole, more preferably 1% to 20% by mole, and still more preferably 2.5% to 20% by mole.

The (meth)acrylic compound (M1) and the other polymerizable compound (M2), from which the constitutional components of the (meth)acrylic polymer and the vinyl polymer are derived, are preferably a compound represented by Formula (b-1). It is preferable that this compound is different from a compound from which a constitutional component having a substituent having 8 or more carbon atoms is derived or a compound from which the above-described constitutional component having a functional group is derived.

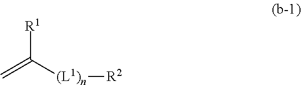

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The number of carbon atoms of the alkyl group has the same meaning as the number of carbon atoms of the alkyl group that constitutes the (meth)acrylic acid alkyl ester compound, where a long-chain alkyl ester having 8 or more carbon atoms or an alkyl ester having 7 or less carbon atoms is preferable.

L¹ is a linking group and is not particularly limited; however, examples thereof include a linking group in the above-described constitutional component having a substituent having 8 or more carbon atoms. A —CO—O— group or a —CO—N(R^{N})— group (R^{N} is as described above) is preferable. The above-described linking group may have any substituent. The number of atoms that constitute the linking group and the number of linking atoms are as described above. Examples of any substituent include a substituent Z described later, and examples thereof include an alkyl group and a halogen atom.

n is 0 or 1 and preferably 1. However, in a case where -(L′)ₙ-R² represents one kind of substituent (for example, an alkyl group), n is set to 0, and R² is set to a substituent (an alkyl group).

In Formula (b-1), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

In addition, the group which may adopt a substituent such as an alkyl group, an aryl group, an alkylene group, or an arylene group may have a substituent within a range where the effect of the present invention is not impaired. The substituent is not particularly limited, and examples thereof include a group selected from the substituent Z described later, where specific examples thereof include a halogen atom.

Examples of the preferred (meth)acrylic compound (M1) include a compound represented by Formula (b-2) or (b-3). It is preferable that this compound is different from a compound from which a constitutional component having a substituent having 8 or more carbon atoms is derived or a compound from which the above-described constitutional component having a functional group is derived.

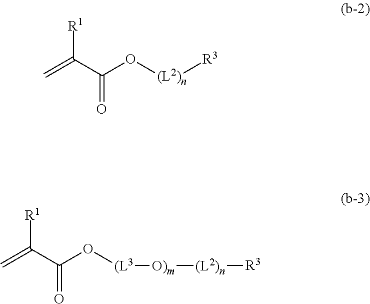

R¹ and n respectively have the same meanings as those in Formula (b-1).
R³ has the same meaning as R².
L² is a linking group, and the description for L¹ described above can be preferably applied thereto.
L³ is a linking group, and the description for L¹ described above can be preferably applied thereto, and it is preferably an alkylene group having 1 to 6 carbon atoms (preferably 1 to 3 carbon atoms).
m is an integer of 1 to 200, and it is preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formulae (b-1) to (b-3), the group which may take a substituent such as an alkyl group, an aryl group, an alkylene group, or an arylene group may have a substituent within a range where the effect of the present invention is not impaired. It suffices that the substituent is a substituent other than the functional group selected from the Group (a) of functional groups. Examples thereof include a group selected from the substituent Z described later, and specific examples thereof include a halogen atom.

The chain polymerization polymer (each constitutional component and raw material compound) may have a substituent. The substituent is not particularly limited, and preferred examples thereof include a group selected from the substituent Z. However, a group other than the functional group included in the above-described group (a) of functional groups is preferable.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, and oleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom, where the heterocyclic group includes an aromatic heterocyclic group and an aliphatic heterocyclic group and examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, and a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO-group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, or a crotonoyloxy group); an aryloyloxy group (preferably an aryloyloxy group having 7 to 23 carbon atoms, for example, a benzoyloxy group or a naphthyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group); an alkoxysilyl group (preferably an alkoxysilyl group having 1 to 20 carbon atoms, for example, a monomethoxysilyl group, a dimethoxysilyl group, a trimethoxysilyl group, or a triethoxysilyl group); an aryloxysilyl group (preferably an aryloxy group having 6 to 42 carbon atoms, for example, a triphenyloxysilyl group); a phosphoryl group (preferably a phosphate group having 0 to 20 carbon atoms, for example, —OP(═O)(R^{P})₂); a phosphonyl group (preferably a phosphonyl group having 0 to 20 carbon atoms, for example, —P(═O)(R^{P})₂); a phosphinyl group (preferably a phosphinyl group having 0 to 20 carbon atoms, for example, —P(R^{P})₂); a phosphonate group (preferably a phosphonate group having 0 to 20 carbon atoms, for example, —PO(OR)₂); a sulfo group (a sulfonate group); a carboxy group; a hydroxy group; a sulfanyl group; a cyano group; and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

The chain polymerization polymer can be synthesized by selecting a raw material compound and polymerizing the raw material compound according to a known method.

The method of incorporating a functional group is not particularly limited, and examples thereof include a method of copolymerizing a compound having a functional group selected from the group (a) of functional groups, a method of using a polymerization initiator having (generating) the above-described functional group or a chain transfer agent, a method of using a polymeric reaction, an ene reaction or ene-thiol reaction with a double bond, and an atom transfer radical polymerization (ATRP) method using a copper catalyst. In addition, a functional group can be introduced by using a functional group that is present in the main chain, the side chain, or the terminal of the polymer, as a reaction point. For example, a functional group selected from the group (a) of functional groups can be introduced by various reactions with a carboxylic acid anhydride group in a polymerized chain using a compound having a functional group.

Specific examples of the polymer that constitutes a polymer binder include polymers synthesized in Examples; however, the present invention is not limited thereto.

The binder (B1) contained in the electrode composition according to the embodiment of the present invention may be one kind or two or more kinds.

The (total) content of the binder (B1) in the electrode composition is as described in the condition (3). In a case where the electrode composition contains two or more kinds of binders (B1), the content of each binder (B1) is appropriately set in a range in which the above-described content is satisfied.

In a case where the electrode composition contains a binder (B2) described later, the (total) content of the binder (B1) may be lower than the content of the binder (B2); however, it is preferably equal to or higher than the content of the binder (B2). This makes it possible to further reinforce the binding property without impairing the excellent dispersion characteristics and the excellent surface properties. The difference (in terms of absolute value) between the (total) content of the binder (B1) and the content of the binder (B2) in 100% by mass of the solid content is not particularly limited, and it can be set to, for example, 0% to 1.5% by mass, more preferably 0% to 1.2% by mass, and still more preferably 0% to 1.0% by mass. In addition, the ratio of the content of the (total) content of the binder (B1) to the content of the binder (B2) (the (total) content of the binder (B1)/the content of the binder (B2)) in 100% by mass of the solid content is not particularly limited; however, it is, for example, preferably 1 to 4 and more preferably 1 to 2.

(Polymer Binder (B2))

The electrode composition according to the embodiment of the present invention may contain one or two or more kinds of non-dissolved type binders that are insoluble in a polymer binder other than the binder (B1), for example, the dispersion medium in the composition. This non-dissolved type binder is preferably a particle-shaped polymer binder (a particulate binder). The shape of this particulate binder is not particularly limited and may be a flat shape, an amorphous shape, or the like; however, a spherical shape or a granular shape is preferable. The average particle diameter of the particulate binder is preferably 1 to 1,000 nm, more preferably 5 to 800 nm, still more preferably 10 to 600 nm, and particularly preferably 50 to 500 nm. The average particle diameter can be measured using the same method as that of the average particle diameter of the inorganic solid electrolyte.

The binder (B2), particularly the polymer (b2) constituting a particulate binder may or may not satisfy the condition (1) and the condition (2); however, it preferably has a molecular weight different from that of the binder (B1). In a case where the polymer (b2) has a mass average molecular weight different from that of the polymer (b1), it is possible to achieve the insurance of the adhesiveness by the mechanical strength of a polymer having a large mass average molecular weight, and the increase in the number of binding points by a polymer having a small mass average molecular weight in a well-balanced manner, thereby obtaining an effect of further enhancing the adhesiveness. The mass average molecular weight of the polymer (b2) is not particularly limited as long as it is different from that of the polymer (b1). Although the mass average molecular weight thereof may be larger or smaller than the mass average molecular weight of the polymer (b1), it is preferably smaller than the mass average molecular weight of the polymer (b1). The mass average molecular weight of the polymer (b2) is preferably in a range of, for example, 3,000 to 2,000,000, and it is preferably 5,000 or more, more preferably 8,000 or more, and still more preferably 10,000 or more in terms of the above-described enhancement effect. The upper limit thereof is preferably 800,000 or less, more preferably 400,000 or less, still more preferably 200,000 or less, and particularly preferably 150,000 or less. The mass average molecular weight of the polymer (b2) can be appropriately adjusted by changing the kind, content, polymerization time, polymerization temperature, and the like of the polymerization initiator.

It is preferable that the polymer (b2) does not react with the inorganic solid electrolyte due to the heating step in the preparation of the electrode composition, the production of the electrode sheet for an all-solid state secondary battery, or the manufacturing of the all-solid state secondary battery, and specifically, it is preferable that the polymer (b1) does not have an ethylenic double bond.

The polymer (b2) is preferably a polymer that exhibits a higher adhesive force (adsorptive force) than the binder (B1) with respect to the inorganic solid electrolyte, the active material, and the conductive auxiliary agent.

For example, the adsorption rate of the particulate binder with respect to the inorganic solid electrolyte is appropriately determined in consideration of the binder (B1); however, it can be set to, for example, 30% or more, and it is preferably set to 40% or more. The upper limit value thereof is not particularly limited; however, it can be set to, for example, 95% or less, and it is preferably set to 90% or less. The adsorption rate to the active material and the conductive auxiliary agent is appropriately determined.

(Adsorption Rate)

In the present invention, the adsorption rate (%) of a binder is a value measured by using an inorganic solid electrolyte and a specific dispersion medium contained in the electrode composition, and it is an indicator that indicates the degree of adsorption of a binder to an inorganic solid electrolyte in this dispersion medium. Here, the adsorption of the binder to the inorganic solid electrolyte includes not only physical adsorption but also chemical adsorption (adsorption by chemical bond formation, adsorption by transfer of electrons, or the like).

In a case where the electrode composition contains a plurality of kinds of inorganic solid electrolytes, the adsorption rate is defined as an adsorption rate with respect to the inorganic solid electrolyte having the same composition (kind and content) as the composition of the inorganic solid electrolyte in the electrode composition. Similarly, also in a case where the electrode composition contains a plurality of kinds of specific dispersion media, the adsorption rate is measured by using a specific dispersion medium having the same composition (the kind and the content) as the dispersion medium in the electrode composition.

It is noted that in a case where the electrode composition contains a plurality of kinds of binders, it is sufficient that the binder (B2) in the electrode composition satisfies the adsorption rate.

The adsorption rate (%) of the binder is measured as follows using the inorganic solid electrolyte, the binder, and the dispersion medium, that are used in the preparation of the electrode composition.

That is, the binder is dissolved in a dispersion medium to prepare a binder solution having a concentration of 1% by mass. The binder solution and the inorganic solid electrolyte are placed in a 15 ml of vial at a proportion such that the mass ratio of the binder in this binder solution to the inorganic solid electrolyte is 42:1, and stirred for 1 hour with a mix rotor at room temperature (25° C.) and a rotation speed of 80 rpm, and then allowed to stand. The supernatant obtained by solid-liquid separation is filtered through a filter having a pore diameter of 1 μm, and the entire amount of the obtained filtrate is dried to be solid, and then the mass of the binder remaining in the filtrate (the mass of the binder that has not adsorbed to the inorganic solid electrolyte) WA is measured. From this mass WA and the mass W_{B} of the binder contained in the binder solution used for the measurement, the adsorption rate of the binder with respect to the inorganic solid electrolyte is calculated according to the following expression. The adsorption rate of the binder is the average value of the adsorption rates obtained by carrying out the above measurement twice.

Adsorption rate (%)=[(W_{B}−W_{A})/W_{B}]×100

In a case where the electrode composition contains the particulate binder exhibiting the adsorption rate as the binder (B2), it is possible to further reinforce the binding property of the solid particles while suppressing an increase in interface resistance without impairing the effect of improving the dispersion characteristics and the application suitability due to the binder (B2). This makes it possible to further increase the rate characteristics of the all-solid state secondary battery, and preferably it is possible to realize still lower resistance.

As the particulate binder, various particulate binders that are used in the manufacturing of an all-solid state secondary battery can be used without particular limitation. Examples thereof include a particulate binder consisting of the above-described chain polymerization polymer and a particulate binder consisting of the above-described sequential polymerization polymer, and a commercially available product may be used. Further, examples thereof also include the binders disclosed in JP2015-088486A, WO2017/145894A, and WO2018/020827A.

The content of the binder (B2), particularly the particulate binder exhibiting the adsorption rate, in the electrode composition, is not particularly limited. However, it is preferably 0.01% to 4% by mass, more preferably 0.05% to 2% by mass, and still more preferably 0.1% to 1.5% by mass in 100% by mass of the solid content, in that dispersion characteristics and application suitability are improved and furthermore, the firm binding property is exhibited. It is noted that the content of the particulate binder is appropriately set within the above-described range; however, it is preferably a content at which the particulate binder is not dissolved in the electrode composition in consideration of the solubility of the particulate binder.

(Combination of Polymer Binder)

As described above, the polymer binder contained in the electrode composition according to the embodiment of the present invention may include two or more kinds thereof in a case where at least one kind of the binder (B1) is contained. In a case where two or more kinds thereof are contained, the number thereof is not particularly limited; however, it is preferably 2 to 5 kinds, and it can be, for example, 2 to 7 kinds.

Examples of the aspect in which the polymer binder contains the binder (B1) include an aspect in which the binder (B1) is contained alone, an aspect in which two or more kinds of binders (B1) are contained, and an aspect in which one or two or more kinds of binders (B1) and the binder (B2) are contained. Among them, an aspect in which one or two or more kinds of binders (B1) and a particulate binder are contained is preferred, and an aspect in which the binder (B1) composed of the polymer (b1) having a mass average molecular weight of 200,000 or more and the binder (B2) composed of the polymer (b2) having a mass average molecular weight of 200,000 or less are contained is more preferable, from the viewpoint that the adhesiveness can be further enhanced in addition to the improvement of the dispersion characteristics and the surface properties.

In a case where the electrode composition according to the embodiment of the present invention contains the binder (B1) and the binder (B2) as the polymer binder, the total content of the polymer binders in the electrode composition is not particularly limited. However, it is preferably 0.1% to 2.0% by mass, more preferably 0.2% to 1.5% by mass, and still more preferably 0.5% to 1.2% by mass, in 100% by mass of the solid content in terms of dispersion characteristics and application suitability, as well as the enhancement of the binding property of solid particles.

In the present invention, the mass ratio [(the mass of the inorganic solid electrolyte+the mass of the active material)/(the total mass of the polymer binder)] of the total mass (the total content) of the inorganic solid electrolyte and the active material to the total content of the polymer binder in 100% by mass of the solid content is preferably in a range of 1,000 to 1. Furthermore, this ratio is more preferably 500 to 2 and still more preferably 100 to 10.

<Dispersion Medium (D)>

The electrode composition according to the embodiment of the present invention contains a dispersion medium that disperses or dissolves each of the above components.

It suffices that such a dispersion medium is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally means a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The dispersion medium preferably has low polarity (is preferably a low-polarity dispersion medium) in terms of dispersion characteristics and in terms of preventing the deterioration (decomposition) of a sulfide-based inorganic solid electrolyte in a case where the sulfide-based inorganic solid electrolyte is used as the inorganic solid electrolyte. For example, the SP value (unit: MPa^{1/2}) can be generally set in a range of 15 to 27; however, it is preferably 17 to 22, more preferably 17.5 to 21, and still more preferably 18 to 20. The difference (in terms of absolute value) in the SP value between the binder (B1) and the dispersion medium (D) is not particularly limited. However, it is preferably 3.0 or less, more preferably 0 to 2.5, and still more preferably 0 to 2.0 in terms of further improving the dispersion characteristics, and it is particularly preferably 0 to 1.7 in terms of further improving application suitability as well. In a case where the electrode composition contains a plurality of kinds of the binders (B1), it is preferable that the difference (in terms of absolute value) in SP value is such that the smallest value (in terms of absolute value) of the difference is within the above-described range.

The SP value of the dispersion medium is defined as a value obtained by converting the SP value calculated according to the Hoy method described above into the unit of MPa¹². In a case where the electrode composition contains two or more kinds of dispersion media, the SP value of the dispersion medium means the SP value of the entire dispersion media, and it is the total sum of the products of the SP values and the mass fractions of the respective dispersion media. Specifically, the calculation is carried out in the same manner as the above-described calculation method for the SP value of the polymer, except that the SP value of each of the dispersion media is used instead of the SP value of the constitutional component.

The SP values (unit is omitted) of the dispersion media are shown below. It is noted that in the following compound names, the alkyl group means a normal alkyl group unless otherwise specified.

MIBK (18.4), diisopropyl ether (16.8), dibutyl ether (17.9), diisopropyl ketone (17.9), DIBK (17.9), butyl butyrate (18.6), butyl acetate (18.9), toluene (18.5), xylene (a mixture of xylene isomers in which the mixing molar ratio between isomers is, ortho-isomer:para-isomer:meta-isomer=1:5:2) (18.7), octane (16.9), ethylcyclohexane (17.1), cyclooctane (18.8), isobutyl ethyl ether (15.3), N-methylpyrrolidone (NMP, SP value: 25.4), perfluorotoluene (SP value: 13.4)

The boiling point of the dispersion medium at normal pressure (1 atm) is not particularly limited; however, it is preferably 90° C. or higher, and it is more preferably 120° C. or higher. The upper limit thereof is preferably 230° C. or lower and more preferably 200° C. or lower.

The dispersion medium contained in the electrode composition according to the embodiment of the present invention may be one kind or may be two or more kinds. Examples of the example thereof in which two or more kinds of dispersion media are contained include mixed xylene (a mixture of o-xylene, p-xylene, m-xylene, and ethylbenzene).

The content of the dispersion medium in the electrode composition is not particularly limited and is set in a range in which the above-described concentration of solid contents is satisfied.

<Lithium Salt>

The electrode composition according to the embodiment of the present invention can also contain a lithium salt (supporting electrolyte). Generally, the lithium salt is preferably a lithium salt that is used for this kind of product and is not particularly limited. For example, lithium salts described in paragraphs 0082 to 0085 of JP2015-088486A are preferable. In a case where the electrode composition according to the embodiment of the present invention contains a lithium salt, the content of the lithium salt is preferably 0.1 part by mass or more and more preferably 5 parts by mass or more with respect to 100 parts by mass of the inorganic solid electrolyte. The upper limit thereof is preferably 50 parts by mass or less and more preferably 20 parts by mass or less.

<Dispersing Agent>

Since the above-described polymer binder (B), particularly the polymer binder (B1) also functions as a dispersing agent, the electrode composition according to the embodiment of the present invention may not contain a dispersing agent other than the polymer binder (B). In a case where the electrode composition contains a dispersing agent other than the polymer binder (B), a dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As components other than the respective components described above, the electrode composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an anti-foaming agent, a leveling agent, a dehydrating agent, or an antioxidant. The ionic liquid is contained in order to further improve the ion conductivity, and the known one in the related art can be used without particular limitation. In addition, a polymer other than the above-described polymer that forms a polymer binder, a typically used binder, or the like may be contained.

(Preparation of Electrode Composition)

The electrode composition according to the embodiment of the present invention can be prepared according to a conventional method. Specifically, it can be prepared as a mixture and preferably as a slurry by mixing the inorganic solid electrolyte (SE), the active material (AC), the conductive auxiliary agent (CA), the polymer binder (B), and the dispersion medium (D), and furthermore, appropriately a lithium salt and any other optionally components, by using, for example, various mixers that are used generally.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser.

The mixing conditions are also not particularly limited. For example, the rotation speed of the self-rotation type mixer or the like can be set to 200 to 3,000 rpm. The mixing atmosphere may be any atmosphere such as atmospheric air, dry air (the dew point: −20° C. or lower), or inert gas (for example, an argon gas, a helium gas, or a nitrogen gas). Since the inorganic solid electrolyte easily reacts with watery moisture, the mixing is preferably carried out under dry air or in an inert gas.

[Electrode Sheet for all-Solid State Secondary Battery]

The electrode sheet for an all-solid state secondary battery according to the embodiment of the present invention (simply, may be also referred to as an electrode sheet) is a sheet-shaped molded body with which an active material layer or electrode (a laminate of an active material layer and a collector) of an all-solid state secondary battery can be formed, and it includes various aspects depending on use applications thereof.

The electrode sheet according to the embodiment of the present invention may be any electrode sheet having an active material layer formed of the above-described electrode composition according to the embodiment of the present invention, and it may be a sheet in which the active material layer is formed on a base material (collector) or may be a sheet which does not have a base material and is formed from an active material layer. The electrode sheet is typically a sheet including the base material (collector) and the active material layer, and examples of an aspect thereof include an aspect including the base material (collector), the active material layer, and the solid electrolyte layer in this order and an aspect including the base material (collector), the active material layer, the solid electrolyte layer, and the active material layer in this order.

In addition, the electrode sheet may have another layer in addition to each of the above-described layers. Examples of the other layer include a protective layer (a peeling sheet) and a coating layer.

The base material is not particularly limited as long as it can support the active material layer, and examples thereof include a sheet body (plate-shaped body) formed of materials described later regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

At least one of the active material layers included in the electrode sheet is formed of the electrode composition according to the embodiment of the present invention. The content of each component in the active material layer formed of the electrode composition according to the embodiment of the present invention is not particularly limited; however, it is preferably synonymous with the content of each component in the solid content of the electrode composition according to the embodiment of the present invention. The thickness of each of the layers forming the electrode sheet according to the embodiment of the present invention is the same as the layer thickness of each of the layers described later regarding the all-solid state secondary battery.

In the present invention, each layer that constitutes a sheet for an all-solid state secondary battery may have a monolayer structure or a multilayer structure.

It is noted that in a case where the solid electrolyte layer or the active material layer is not formed of the electrode composition according to the embodiment of the present invention, it is formed of a general constitutional layer forming material.

The electrode sheet according to the embodiment of the present invention has an active material layer that is formed of the electrode composition according to the embodiment of the present invention, and it has the active material layer having a flat surface on which solid particles are firmly bonded to each other. As a result, in a case where the electrode sheet for an all-solid state secondary battery according to the embodiment of the present invention is used as an active material layer of an all-solid state secondary battery, it is possible to realize excellent rate characteristics of the all-solid state secondary battery. In particular, in the electrode sheet for an all-solid state secondary battery, in which the active material layer is formed on the collector, the active material layer and the collector exhibit firm adhesiveness, which makes it possible to realize the further improvement of the rate characteristics. As described above, the electrode sheet for an all-solid state secondary battery according to the present invention is suitably used as an active material layer of an all-solid state secondary battery and suitably as a sheet-shape member that forms an electrode (that is incorporated as an active material layer or an electrode).

[Manufacturing Method for Electrode Sheet for all-Solid State Secondary Battery]

A manufacturing method for an electrode sheet for an all-solid state secondary battery according to the embodiment of the present invention is not particularly limited. The electrode sheet for an all-solid state secondary battery according to the embodiment of the present invention can be manufactured by forming the active material layer using the electrode composition according to the embodiment of the present invention. Examples thereof include a method of forming a film (carrying out coating and drying) of the electrode composition according to the embodiment of the present invention on the surface of a base material (another layer may be interposed) to form a layer (a coated and dried layer) consisting of the electrode composition. This makes it possible to produce an electrode sheet for an all-solid state secondary battery including a base material and a coated and dried layer. In particular, in a case of employing a collector as the base material, the adhesion between the collector and the active material layer (the coated and dried layer) can be strengthened. Here, the coated and dried layer refers to a layer formed by applying the electrode composition according to the embodiment of the present invention and drying the dispersion medium (that is, a layer formed using the electrode composition according to the embodiment of the present invention and consisting of a composition obtained by removing the dispersion medium from the electrode composition according to the embodiment of the present invention). In the active material layer and the coated and dried layer, the dispersion medium may remain within a range where the effect of the present invention is not impaired, and the residual amount thereof, for example, in a coated and dried layer may be 3% by mass or lower.

In the manufacturing method for an electrode sheet for an all-solid state secondary battery according to the embodiment of the present invention, each of the steps such as coating and drying will be described in the following manufacturing method for an all-solid state secondary battery.

In this way, it is possible to produce an electrode sheet for an all-solid state secondary battery having an active material layer that has been produced by appropriately subjecting an active material layer consisting of a coated and dried layer or a coated and dried layer to a pressurization treatment or the like. The pressurizing condition and the like will be described later in the section of the manufacturing method for an all-solid state secondary battery.

In addition, in the manufacturing method for an electrode sheet for an all-solid state secondary battery according to the embodiment of the present invention, the substrate, the protective layer (particularly a peeling sheet), or the like can also be stripped.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) that constitutes an all-solid state secondary battery may have a monolayer structure or a multilayer structure.

In the all-solid state secondary battery according to the embodiment of the present invention, it is preferable that at least one layer of the negative electrode active material layer or the positive electrode active material layer is formed of the electrode composition according to the aspect of the present invention and at least the positive electrode active material layer is formed of the electrode composition according to the aspect of the present invention. In addition, an aspect in which both the negative electrode active material layer and the positive electrode active material layer are formed of the electrode composition according to the embodiment of the present invention is also one of the preferred aspects. In addition, it is preferable that any one of the negative electrode (a laminate of a negative electrode collector and a negative electrode collector) and the positive electrode (a laminate of a positive electrode collector and a positive electrode collector), preferably the positive electrode is formed of the electrode sheet for an all-solid state secondary battery according to the embodiment of the present invention, and an aspect in which both of them are formed of the electrode sheet for an all-solid state secondary battery according to the present invention is also one of the preferred aspects.

In the active material layer formed of the electrode composition according to the embodiment of the present invention, it is preferable that the kinds of components to be included and the content thereof are the same as those of the solid content of the electrode composition according to the embodiment of the present invention.

It is noted that in a case where the active material layer is not formed of the electrode composition according to the embodiment of the present invention, the active material layer and the solid electrolyte layer can be produced using known materials.

In the present invention, each constitutional layer (including a collector and the like) that constitutes an all-solid state secondary battery may have a monolayer structure or a multilayer structure.

<Positive Electrode Active Material Layer and Negative Electrode Active Material Layer>

The thickness of each of the negative electrode active material layer and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

The active material layer having the above-described thickness may be a single layer (single application of an electrode composition) or may be a plurality of layers (a plurality of times of application of an electrode composition). However, in terms of resistance reduction and productivity, it is preferable to form, as a single layer, an active material layer having a large layer thickness using the electrode composition according to the embodiment of the present invention, which enables layer thickening by increasing the concentration. The layer thickness of the layer-thickened single-layer active material, which can be preferably formed with the electrode composition according to the embodiment of the present invention, can be set to, for example, 70 μm or more and can also be set to furthermore, 100 μm or more.

<Solid Electrolyte Layer>

The solid electrolyte layer is formed using a known material that is capable of forming a solid electrolyte layer of an all-solid state secondary battery. The thickness thereof is not particularly limited; however, it is preferably 10 to 1,000 μm, and more preferably 20 μm or more and less than 500 μm.

<Collector>

It is preferable that each of the positive electrode active material layer and the negative electrode active material layer includes a collector on the side opposite to the solid electrolyte layer. Such a positive electrode collector and such a negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is; however, it is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

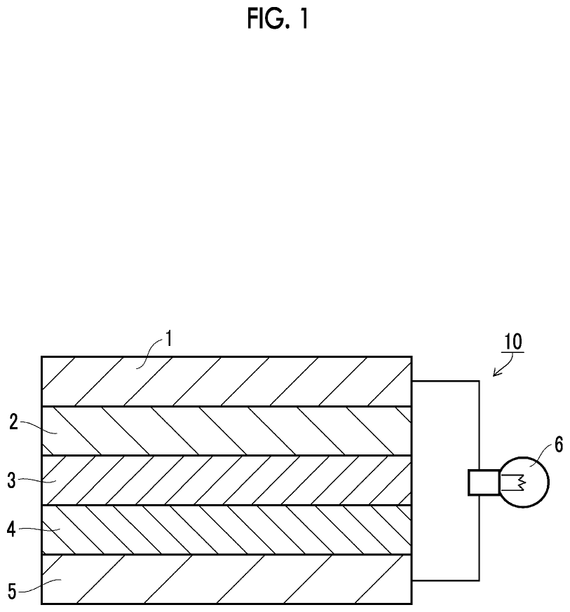

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is placed in a 2032-type coin case, the all-solid state secondary battery will be referred to as a laminate for an all-solid state secondary battery, and a battery produced by placing this laminate for an all-solid state secondary battery in a 2032-type coin case will be referred to as a (coin-type) all-solid state secondary battery, whereby both batteries may be distinctively referred to in some cases.

(Solid Electrolyte Layer)

As the solid electrolyte layer, a solid electrolyte layer in the related art, which is applied to an all-solid state secondary battery, can be used without particular limitation. This solid electrolyte layer appropriately contains an inorganic solid electrolyte having an ion conductivity of a metal belonging to Group 1 or Group 2 in the periodic table, any component described above, and the like, and it generally does not contain an active material.

(Positive Electrode Active Material Layer and Negative Electrode Active Material Layer)

In the all-solid state secondary battery 10, both the positive electrode active material layer and the negative electrode active material layer are formed of the electrode composition according to the embodiment of the present invention. Preferably, the positive electrode in which the positive electrode active material layer and the positive electrode collector are laminated, and the negative electrode in which the negative electrode active material layer and the negative electrode collector are laminated are formed of the electrode sheet according to the embodiment of the present invention, to which a collector is applied as a base material.

The positive electrode active material layer contains an inorganic solid electrolyte having an ion conductivity of a metal belonging to Group 1 or Group 2 in the periodic table, a positive electrode active material, the polymer binder (B), and a conductive auxiliary agent, and any component described above and the like within a range where the effect of the present invention is not impaired.

The negative electrode active material layer contains an inorganic solid electrolyte having an ion conductivity of a metal belonging to Group 1 or Group 2 in the periodic table, a negative electrode active material, the polymer binder (B), and a conductive auxiliary agent, and any component described above and the like within a range where the effect of the present invention is not impaired. In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above-described thickness of the above negative electrode active material layer.

The kinds of the respective components contained in the positive electrode active material layer 4, the solid electrolyte layer 3, and the negative electrode active material layer 2, particularly the kinds of the inorganic solid electrolyte, the conductive auxiliary agent, and the polymer binder may be the same or different from each other.

In the present invention, in a case of forming the active material layer with the electrode composition according to the embodiment of the present invention, it is possible to realize an all-solid state secondary battery having excellent rate characteristics.

(Collector)

The positive electrode collector 5 and the negative electrode collector 1 are as described above.

In a case where the all-solid state secondary battery 10 has a constitutional layer other than the constitutional layer formed of the electrode composition according to the embodiment of the present invention, a layer formed of a known constitutional layer forming material can also be applied.

In addition, each layer may be constituted of a single layer or multiple layers.

[Manufacture of all-Solid State Secondary Battery]

The all-solid state secondary battery can be manufactured according to a conventional method. Specifically, the all-solid state secondary battery can be manufactured by forming at least one active material layer by using the electrode composition according to the embodiment of the present invention or the like, and then forming a solid electrolyte layer and appropriately the other active material layer or an electrode by using the known materials.

The all-solid state secondary battery according to the embodiment of the present invention can be manufactured by carrying out a method (a manufacturing method for an electrode sheet for an all-solid state secondary battery according to the embodiment of the present invention) which includes (is carried out through) a step of appropriately coating and drying on a surface of a base material (for example, a metal foil serving as a collector) with the electrode composition according to the embodiment of the present invention to form a coating film (form a film).

For example, an electrode composition which contains a positive electrode active material and serves as a positive electrode material (a positive electrode composition) is applied onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Further, the electrode composition containing a negative electrode active material as a negative electrode material (a negative electrode composition) is formed into a film on the solid electrolyte layer to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method of each layer in reverse order to form a negative electrode active material layer, a solid electrolyte layer, and a positive electrode active material layer on a negative electrode collector and overlaying a positive electrode collector thereon.

As another method, the following method can be exemplified. That is, the positive electrode sheet for an all-solid state secondary battery is produced as described above. In addition, an electrode composition which contains a negative electrode active material and serves as a negative electrode material (a negative electrode composition) is formed into a film on a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated such that the solid electrolyte layer removed from the base material is sandwiched therebetween. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this way, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this way, an all-solid state secondary battery can be manufactured. The pressurizing method and the pressurizing conditions in this method are not particularly limited, and a method and pressurizing conditions described in the pressurization step, which will be described later, can be applied.

The active material layer or the like can also be formed on the substrate or the active material layer, for example, by pressure-molding the electrode composition or the like under a pressurizing condition described later, or the solid electrolyte or a sheet molded body of the active material.

In the above-described manufacturing method, it suffices that the electrode composition according to the embodiment of the present invention is used for any one of the positive electrode composition or the negative electrode composition, and the electrode composition according to the embodiment of the present invention can also be used for both the positive electrode composition and the negative electrode composition.

<Formation (Film Formation) of Each Layer>

The coating method for each composition is not particularly limited and can be appropriately selected. Examples thereof include wet-type coating methods such as coating (preferably wet-type coating), spray coating, spin coating, dip coating, slit coating, stripe coating, and bar coating.

The applied composition is preferably subjected to a drying treatment (a heating treatment). The drying treatment may be carried out each time after the composition is applied or may be carried out after it is subjected to multilayer application. The drying temperature is not particularly limited as long as the dispersion medium can be removed, and it is appropriately set according to the boiling point of the dispersion medium. The lower limit of the drying temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a good application suitability (adhesiveness) and a good ion conductivity even without pressurization.

In a case where the electrode composition according to the embodiment of the present invention is applied and dried as described above, it is possible to suppress the variation in the contact state and bind solid particles, and furthermore, it is possible to form a coated and dried layer having a flat surface.

After applying each composition, it is preferable to pressurize each layer or the all-solid state secondary battery after superimposing the constitutional layers or producing the all-solid state secondary battery. Examples of the pressurizing methods include a method using a hydraulic cylinder press machine. The pressurizing force is not particularly limited; however, it is generally preferably in a range of 5 to 1,500 MPa.

In addition, each of the applied compositions may be heated while being pressurized. The heating temperature is not particularly limited; however, it is generally in a range of 30° C. to 300° C. The press can also be applied at a temperature higher than the glass transition temperature of the inorganic solid electrolyte. It is also possible to carry out pressing at a temperature higher than the glass transition temperature of the polymer that constitutes a polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out the transfer.

The atmosphere in the film forming method (coating, drying, and pressurization (under heating) is not particularly limited and may be any atmosphere such as atmospheric air, dry air (the dew point: −20° C. or lower), or inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the electrode sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

### 1. Polymer Synthesis

Polymers B-1A to B-1F (collectively referred to as B-1), B-2 to B-14, and T-1 represented by the following chemical formulae were synthesized as follows.

### Synthesis Example B-1A: Synthesis of Polymer B-1A and Preparation of Binder Solution B-1A

To a 100 mL volumetric flask, 4.2 g of methyl methacrylate (manufactured by Tokyo Chemical Industry Co., Ltd.), 95.5 g of dodecyl acrylate (manufactured by Tokyo Chemical Industry Co., Ltd.), 0.3 g of maleic acid anhydride, and 3.6 g of a polymerization initiator V-601 (product name, manufactured by FUJIFILM Wako Pure Chemical Corporation) were added and dissolved in 36 g of butyl butyrate to prepare a monomer solution. To a 300 mL three-neck flask, 18 g of butyl butyrate was added and stirred at 80° C., and then the above monomer solution was added dropwise thereto over 2 hours. After completion of the dropwise addition, the temperature was raised to 90° C., and stirring was carried out for 2 hours to synthesize a polymer B-1A (an acrylic polymer). The obtained solution was reprecipitated in methanol and redissolved in toluene.

In this way, an acrylic polymer B-1A having a mass average molecular weight of 6,000 was synthesized to prepare a binder solution B-1A (concentration: 10% by mass) consisting of this polymer.

### Synthesis Examples B-1B to B-1F: Synthesis of Polymers B-1B to B-1F and Preparation of Binder Solutions B-1B to B-1F

Each of acrylic polymers B-1B to B-1F having the mass average molecular weights shown in Table 1 was synthesized in the same manner as in Synthesis Example B-1A, except that in Synthesis Example B-1A, the amount of the polymerization initiator V-601 (product name, manufactured by FUJIFILM Wako Pure Chemical Corporation) was appropriately changed in order to adjust the molecular weight, thereby preparing binder solutions B-1B and B-1F (concentration: 10% by mass) consisting of these polymers, respectively.

### Synthesis Example B-2: Synthesis of Polymer B-2 and Preparation of Binder Solution B-2

100 parts by mass of ion exchange water, 48 parts by mass of vinylidene fluoride, 30 parts by mass of hexafluoropropene, and 22 parts by mass of tetrafluoroethylene were added to an autoclave, and 1 part by mass of a polymerization initiator PEROYL IPP (product name, chemical name: diisopropyl peroxydicarbonate, manufactured by NOF CORPORATION) was further added thereto and stirred at 40° C. for 24 hours. After stirring, the precipitate was filtered and dried at 100° C. for 10 hours. 150 parts by mass of toluene or N-methylpyrrolidone was added with respect to 10 parts by mass of the obtained polymer and dissolved.

In this manner, a fluoropolymer B-2 as a random copolymer was synthesized to prepare a binder solution B-2 (concentration: 10% by mass) consisting of this polymer.

### Synthesis Examples B-3 and B-4: Synthesis of Binders B-3 and B-4, and Preparation of Binder Solutions B-3 and B-4

Each of acrylic polymers B-3 and B-4 was synthesized in the same manner as in Synthesis Example B-1D, except that in Synthesis Example B-1D, a compound from which each constitutional component was derived was used instead of methyl methacrylate so that the structure shown in the following structural formula was obtained, and the amount of the polymerization initiator V-601 (product name, manufactured by FUJIFILM Wako Pure Chemical Corporation) was appropriately changed in order to adjust the molecular weight, thereby preparing binder solutions B-3 and B-4 (concentration: 10% by mass) consisting of these polymers, respectively.

### Synthesis Example B-5: Synthesis of Polymer B-5 and Preparation of Binder Dispersion Liquid B-5

Specifically, 300 g of cyclohexane as a solvent and 1.0 mL of sec-butyl lithium (1.3 M, manufactured by FUJIFILM Wako Pure Chemical Corporation) as a polymerization initiator were charged into a pressure-resistant container that had been subjected to nitrogen substitution and drying, and after raising the temperature to 50° C., 27.7 g of styrene was added thereto carry out polymerization for 2 hours, 23.1 g of 1,3-butadiene and 21.6 g of ethylene were subsequently added thereto carry out polymerization for 3 hours, and then 27.7 g of styrene was added thereto carry out polymerization for 2 hours. The obtained solution was reprecipitated in methanol and dried to obtain a solid, and 3 parts by mass of 2,6-di-t-butyl-p-cresol was added with respect to 100 parts by mass of the polymer obtained solid, and then the reaction was carried out at 180° C. for 5 hours. The obtained solution was reprecipitated in acetonitrile, and the obtained solid was dried at 80° C. to obtain a polymer (a dry solid product). Then, in a pressure-resistant container, the entire amount of the polymer obtained as above was dissolved in 400 parts by mass of cyclohexane, and then 5% by mass of palladium carbon (palladium carrying amount: 5% by mass) with respect to the above-described polymer was added as a hydrogenation catalyst, and the mixture was subjected to a reaction under the conditions of a hydrogen pressure of 2 MPa and 150° C. for 10 hours. After allowing cooling and pressure release, palladium carbon was removed by filtration, the filtrate was concentrated, and further vacuum dried to obtain a hydrocarbon polymer B-5.

Then, the mixture was mixed with toluene and dispersed in the form of particles to prepare a binder dispersion liquid B-5 (concentration: 10% by mass). The average particle diameter of the binder B-5 was 250 nm.

### Synthesis Example B-6: Synthesis of Binder B-6 and Preparation of Binder Solution B-6

A acrylic polymer B-6 was synthesized in the same manner as in Synthesis Example B-1, except that in Synthesis Example B-1, a compound from which each constitutional component was derived was used so that the structure and the composition (the content of the constitutional component) were as shown in the following chemical formula and that the amount of the polymerization initiator V-601 (trade name, manufactured by FUJIFILM Wako Pure Chemical Corporation) was appropriately changed in order to adjust the molecular weight, thereby preparing a binder solution B-6 (concentration: 10% by mass) consisting of this polymer.

### Synthesis Example B-7: Synthesis of Polymer B-7 and Preparation of Binder Solution B-7

A hydrocarbon polymer B-7 was synthesized in the same manner as in Synthesis Example B-5, except that in Synthesis Example B-5, 2.5 parts by mass of maleic acid anhydride was further added in the step of adding 3 parts by mass of 2,6-di-t-butyl-p-cresol, thereby preparing a binder solution B-7 (concentration: 10% by mass) consisting of this polymer.

### Synthesis Example B-8: Synthesis of Polymer B-8 and Preparation of Binder Solution B-8

A vinyl polymer (binder) B-8 was synthesized in the same manner as in Synthesis Example B-1, except that in Synthesis Example B-1, 37.7 g of butyl acrylate and 62.3 g of styrene were used instead of methyl methacrylate, dodecyl acrylate, and maleic acid anhydride, and the amount of the polymerization initiator V-601 (product name, manufactured by FUJIFILM Wako Pure Chemical Corporation) was appropriately changed in order to adjust the molecular weight, thereby preparing a binder solution B-8 (concentration: 10% by mass) consisting of this polymer.

### Synthesis Examples B-9 and B-10: Synthesis of Polymers B-9 and B-10, and Preparation of Binder Solutions B-9 and B-10

Each of acrylic polymers B-9 and B-10 was synthesized in the same manner as in Synthesis Example B-1, except that in Synthesis Example B-1, a compound from which each constitutional component was derived was used so that the structure and the composition (the content of the constitutional component) were as shown in the following chemical formula and that the amount of the polymerization initiator V-601 (trade name, manufactured by FUJIFILM Wako Pure Chemical Corporation) was appropriately changed in order to adjust the molecular weight, thereby preparing binder solutions B-9 and B-10 (concentration: 10% by mass) consisting of these polymers, respectively.

### Synthesis Example B-11: Synthesis of Polymer B-11 and Preparation of Binder Solution B-11

An acrylic polymer (binder) B-11 was synthesized in the same manner as in Synthesis Example B-1, except that in Synthesis Example B-1, AS-6 (product name, a styrene macromonomer, number average molecular weight: 6,000, manufactured by TOAGOSEI Co., Ltd.) was used instead of methyl methacrylate, and the amount of the polymerization initiator V-601 (product name, manufactured by FUJIFILM Wako Pure Chemical Corporation) was appropriately changed in order to adjust the molecular weight, thereby preparing a binder solution B-11 (concentration: 10% by mass) consisting of this polymer.

### Synthesis Examples B-12 to B-14: Synthesis of Polymers B-12 to B-14 and Preparation of Binder Solutions B-12 to B-14

Each of acrylic polymers B-12 to B-14 was synthesized in the same manner as in Synthesis Example B-1, except that in Synthesis Example B-1, a compound from which each constitutional component was derived was used so that the structure and the composition (the content of the constitutional component) were as shown in the following chemical formula and that the amount of the polymerization initiator V-601 (trade name, manufactured by FUJIFILM Wako Pure Chemical Corporation) was appropriately changed in order to adjust the molecular weight, thereby preparing binder solutions B-12 to B-14 (concentration: 10% by mass) consisting of these polymers, respectively.

### Synthesis Example T-1: Synthesis of Particulate Binder T-1 and Preparation of Particulate Binder Dispersion Liquid T-1

A particulate binder T-1 was synthesized according to the method described in JP2015-088486A.

That is, to a 2 L three-neck flask equipped with a reflux condenser and a gas introduction cock, 7.2 g of a heptane solution of 40% by mass of the following macromonomer M-1, 12.4 g of methyl acrylate (MA), and 6.7 g of acrylic acid (AA), 207 g of heptane (manufactured by FUJIFILM Wako Pure Chemical Corporation), and 1.4 g of azoisobutyronitrile were added, nitrogen gas was introduced at a flow rate of 200 mL/min for 10 minutes, and then the temperature was raised to 100° C. A liquid (a liquid obtained by mixing 846 g of the heptane solution of 40% by mass of the macromonomer M-1, 222.8 g of methyl acrylate, 75.0 g of acrylic acid, 300.0 g of heptane, and 2.1 g of azoisobutyronitrile) prepared in a separate container was dropwise added thereto over 4 hours. After the dropwise addition was completed, 0.5 g of azoisobutyronitrile was added thereto. Then, the mixture was stirred at 100° C. for 2 hours, cooled to room temperature, and filtered to obtain a particulate binder dispersion liquid T-1 (concentration: 39.2% by mass) consisting of an acrylic polymer (A-1). The average particle diameter of the particulate binder in this dispersion liquid was 180 nm, and the adsorption rate of the particulate binder with respect to the inorganic solid electrolyte according to the above-described measuring method was 86%.

### Synthesis Example of Macromonomer M-1

A self-condensate of 12-hydroxystearic acid (manufactured by FUJIFILM Wako Pure Chemical Corporation) (number average molecular weight in GPC polystyrene standard: 2,000) was reacted with glycidyl methacrylate (manufactured by Tokyo Chemical Industry Co., Ltd.) to form a macromonomer, which was subsequently polymerized with methyl methacrylate and glycidyl methacrylate (manufactured by Tokyo Chemical Industry Co., Ltd.) at a ratio of 1:0.99:0.01 (molar ratio) to obtain a polymer, with which acrylic acid (manufactured by FUJIFILM Wako Pure Chemical Corporation) was subsequently reacted to obtain a macromonomer M-1. The SP value of this macromonomer M-1 was 9.3, and the number average molecular weight thereof was 11,000. The SP value and the number average molecular weight of the macromonomer are values calculated according to the above methods.

Each of the polymers synthesized is shown below. However, since the polymers B-1A to B-1F have the same composition except for the mass average molecular weight, they are described as the polymers B-1. The number at the lower right of each constitutional component indicates the content (% by mole). In the following structural formulae, Me represents a methyl group.

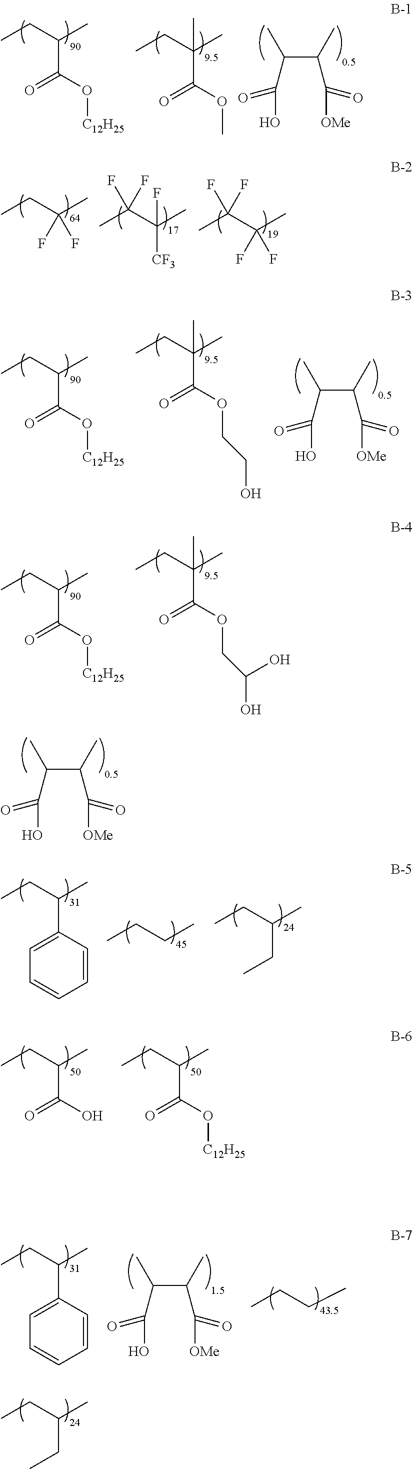

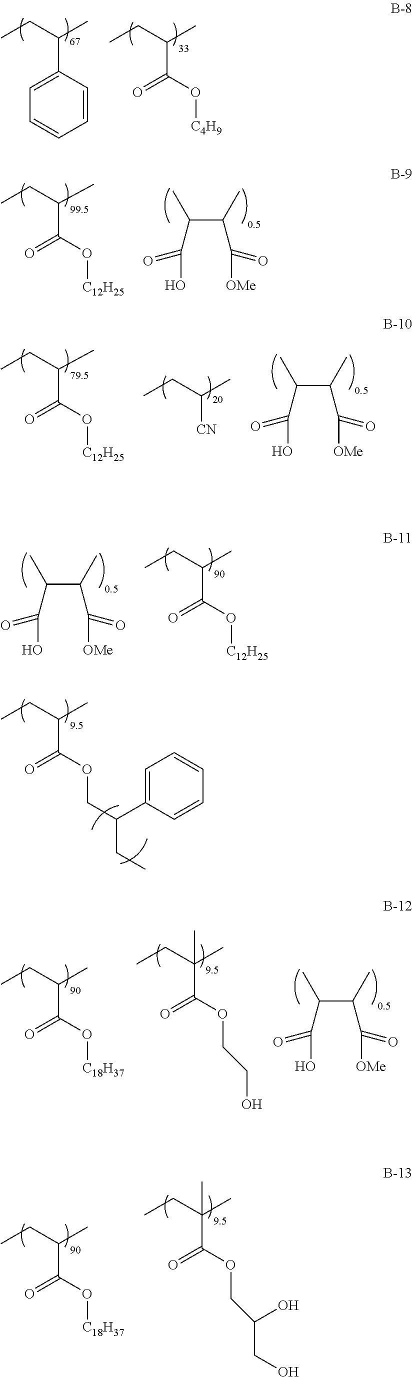

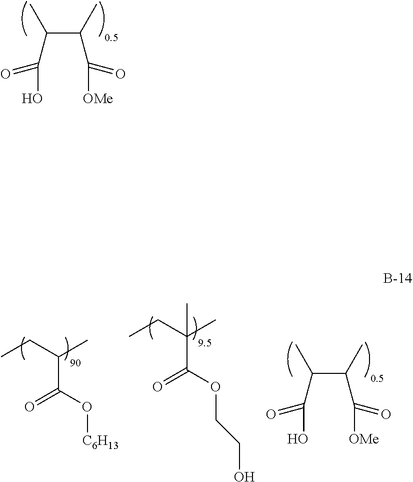

The mass average molecular weight (Mw), the value of the polarity element of the surface energy, and the SP value of each synthesized polymer (binder) were measured or calculated based on the above-described methods. These results are shown in Table 1.

TABLE 1

| | Mass average | | SP value |
|---|---|---|---|
| Polymer No. | molecular weight | Polarity element | (MPa^{1/2}) |
| B-1A | 6,000 | 0.6 | 18.9 |
| B-1B | 120,000 | 0.6 | 18.9 |
| B-1C | 200,000 | 0.6 | 18.9 |
| B-1D | 400,000 | 0.6 | 18.9 |
| B-1E | 1,000,000 | 0.6 | 18.9 |
| B-1F | 2.500,000 | 0.6 | 18.9 |
| B-2 | 400,000 | 0.0 | 12.0 |
| B-3 | 400,000 | 1.0 | 18.4 |
| B-4 | 400,000 | 3.0 | 17.9 |
| B-5 | 130,000 | 0.0 | 17.8 |
| B-6 | 410,000 | 1.2 | 19.9 |
| B-7 | 420,000 | 0.8 | 18.3 |
| B-8 | 390,000 | 0.1 | 19.2 |
| B-9 | 380,000 | 0.5 | 18.8 |
| B-10 | 400,000 | 0.6 | 19.0 |
| B-11 | 390,000 | 0.7 | 18.3 |
| B-12 | 430,000 | 0.6 | 17.9 |
| B-13 | 390,000 | 3.2 | 18.0 |
| B-14 | 410,000 | 0.6 | 18.9 |
| T-1 | 60,000 | 0.3 | 21.5 |

### 2. Synthesis of Sulfide-Based Inorganic Solid Electrolyte

### Synthesis Example S-1

A sulfide-based inorganic solid electrolyte was synthesized with reference to a non-patent document of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >990%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling (micronization) was carried out at a temperature of 25° C. and a rotation speed of 510 rpm for 24 hours, thereby obtaining yellow powder (6.20 g) of a sulfide-based inorganic solid electrolyte (Li—P—S-based glass, hereinafter, may be referred to as LPS).

In this manner, an inorganic solid electrolyte LPS1 having a particle diameter of 5 μm was synthesized.

### Synthesis Example S-2: Synthesis of LPS2 Having Particle Diameter of 3 μm

An inorganic solid electrolyte LPS2 having a particle diameter of 3 μm was synthesized in the same manner as in Synthesis Example S-1, except that in Synthesis Example S-1, mechanical milling was carried out for 48 hours.

### Synthesis Example S-3: Synthesis of LPS3 Having Particle Diameter of 0.5 μm

An inorganic solid electrolyte LPS3 having a particle diameter of 0.5 μm was synthesized in the same manner as in Synthesis Example S-1, except that in Synthesis Example S-1, mechanical milling was carried out for 120 hours.

### Synthesis Example S-4: Synthesis of LPS4 Having Particle Diameter of 0.3 μm

An inorganic solid electrolyte LPS4 having a particle diameter of 0.3 μm was synthesized in the same manner as in Synthesis Example S-1, except that in Synthesis Example S-1, mechanical milling was carried out for 150 hours.

For an LLZ having a particle diameter of 3 μm, a commercially available LLZ (Li₇La₃Zr₂O₁₂; a particle diameter: 3 μm, manufactured by Toshima Manufacturing Co., Ltd.) was prepared.

In addition, as an acetylene black (AB1) having a specific surface area of 60 m²/g, a commercially available acetylene black (manufactured by Denka Company Limited, a specific surface area: 60 m²/g) was prepared.

As an acetylene black (AB2) having a specific surface area of 140 m²/g, a commercially available acetylene black (manufactured by Denka Company Limited, a specific surface area: 140 m²/g) was prepared.

### Example 1

<Preparation of Positive Electrode Composition (Slurry)>

2.8 g of the inorganic solid electrolyte shown in Table 2-1 and the dispersion medium shown in Table 2-2 were put into a container for a self-rotation type mixer (ARE-310, manufactured by THINKY CORPORATION) so that the content of the dispersion medium in the composition for a positive electrode was 70% by mass. Then, this container was set in the self-rotation type mixer ARE-310 (product name), and mixing was carried out for 2 minutes at a temperature of 25° C. and a rotation speed of 2,000 rpm. Then, LiNi_{1/3}Co_{1/3}Mn_{1/3}O₂ (NMC, manufactured by Sigma-Aldrich Co., LLC) as a positive electrode active material, acetylene black (AB) shown in Table 2-1 as a conductive auxiliary agent, and the binder solution (B1) or the binder dispersion liquid (B2) shown in Table 2-2 were put into this container at a proportion which leads to the content shown in Table 2-1 and Table 2-2 (collectively referred to as Table 2), the container was set in a self-rotation type mixer ARE-310 (product name), and mixing was carried out for 2 minutes under the conditions of 25° C. and a rotation speed of 2,000 rpm to prepare each of positive electrode compositions (slurries) P-1 to P-24.

It is noted that in the positive electrode composition P-20, the binder solution (B1) and the binder dispersion liquid (B2) were mixed at a proportion which leads to the content (solid content) shown in Table 2 and a mass ratio of 1:1.

<Preparation of Negative Electrode Composition (Slurry)>

2.8 g of the inorganic solid electrolyte shown in Table 3-1, 0.06 g (in terms of solid content mass) of the binder solution (B1) shown in Table 3-2, and the dispersion medium described in Table 3-2 were put into a container for a self-rotation type mixer (ARE-310) so that the content of the dispersion medium in the negative electrode composition was 70% by mass. Then, this container was set in the self-rotation type mixer ARE-310 (product name) manufactured by THINKY CORPORATION, and mixing was carried out for 2 minutes under the conditions of 25° C. and the rotation speed of 2,000 rpm. Then, 3.11 g of silicon (Si, manufactured by Sigma-Aldrich Co., LLC) as the negative electrode active material shown in Table 3-1 and 0.25 g of acetylene black (AB1) as the conductive auxiliary agent shown in Table 3-1 were put into the container, the container was set in the same manner in the self-rotation type mixer ARE-310 (product name), and mixing was carried out for 2 minutes under the conditions of 25° C. and the rotation speed of 2,000 rpm to prepare each of negative electrode compositions (slurries) N-1 to N-10.

Table 2, and Table 3-1 and Table 3-2 (collectively referred to as Table 3) show the results obtained by measuring, based on the above methods, the particle diameter and the specific surface area of each of the inorganic solid electrolyte, the active material, and the conductive auxiliary agent, which had been used in the preparation of the electrode composition, and the results obtained by calculating, based on the above methods, the specific surface area of the forming mixture in each electrode composition.

In addition, the SP value of the dispersion medium and the difference (in terms of absolute value) between the SP value of the dispersion medium and the SP value of the polymer forming the binder (B1) were calculated and are shown in Table 2 and Table 3.

It is noted that regarding the combination of the binder and the dispersion medium used in the preparation of the electrode compositions shown in Table 2 and Table 3 below, as a result of determining the solubility of the polymers B-1 to B-4, B-9, and B-14 synthesized as above, in the dispersion medium, according to the transmittance measurement described above, the solubility was 10% by mass or more in any case. On the other hand, the solubility of the polymers B-5 and T-1 was less than 10% by mass.

Further, each of the viscosity of each electrode composition at 25° C. (the viscosity at a shear rate of 10 s⁻¹, denoted as “25° C.” in the table) and the viscosity at a shear rate of 20 s⁻¹ was measured based on the above method. The obtained viscosity was used to determine each of “the approximate value of the viscosity at a shear rate of 1 s⁻¹ in the above-described “viscosity characteristics” (denoted as “Approximate value” in the table)” and “the absolute value of the exponent part (denoted as “Exponent part” in the table), based on the above method. These results are shown in Table 2 and Table 3.

It is noted that in each table, the following units are omitted; the unit of the particle diameter (m), the unit of the specific surface area (m²/g), the unit of the content (% by mass), the unit of the polarity element (mN/m), the unit of the SP value (MPa^{1/2}), and the unit of the difference (in terms of absolute value) between SP values (MPa^{1/2}).

| | | | | | | | | | | | | | Specific |
|---|---|---|---|---|---|---|---|---|---|---|---|---|---|
| | Positive electrode active material (AC) | | | | Inorganic solid electrolyte (SE) | | | | Conductive auxilizry agent (CA) | | | | surface |
| | | | Specific | | | | Specific | | | | Specific | | area of |
| Composition | | Particle | surface | | | Particle | surface | | | Particle | surface | | forming |
| No. | Kind | diameter | area | Content | Kind | diameter | area | Content | Kind | diameter | area | Content | mixture |
| P-1 | NMC | 4 | 5 | 75 | LPS2 | 3 | 10 | 22 | AB1 | 0.04 | 60 | 3 | 7.8 |
| P-2 | NMC | 4 | 5 | 75 | LPS2 | 3 | 10 | 21 | AB1 | 0.04 | 60 | 3 | 7.7 |
| P-3 | NMC | 4 | 5 | 75 | LPS2 | 3 | 10 | 21 | AB1 | 0.04 | 60 | 3 | 7.7 |
| P-4 | NMC | 4 | 5 | 75 | LPS2 | 3 | 10 | 21 | AB1 | 0.04 | 60 | 3 | 7.7 |
| P-5 | NMC | 4 | 5 | 75 | LPS2 | 3 | 10 | 21 | AB1 | 0.04 | 60 | 3 | 7.7 |
| P-6 | NMC | 4 | 5 | 75 | LPS2 | 3 | 10 | 21 | AB1 | 0.04 | 60 | 3 | 7.7 |
| P-7 | NMC | 4 | 5 | 75 | LPS2 | 3 | 10 | 21 | AB1 | 0.04 | 60 | 3 | 7.7 |
| P-8 | NMC | 4 | 5 | 75 | LPS2 | 3 | 10 | 21 | AB1 | 0.04 | 60 | 3 | 7.7 |
| P-9 | NMC | 4 | 5 | 75 | LPS2 | 3 | 10 | 21 | AB1 | 0.04 | 60 | 3 | 7.7 |
| P-10 | NMC | 4 | 5 | 75 | LPS2 | 3 | 10 | 17 | AB1 | 0.04 | 60 | 3 | 7.3 |
| P-11 | NMC | 4 | 5 | 75 | LPS2 | 3 | 10 | 21 | AB1 | 0.04 | 60 | 3 | 7.7 |
| P-12 | NMC | 4 | 5 | 75 | LPS2 | 3 | 10 | 21 | AB1 | 0.04 | 60 | 3 | 7.7 |
| P-13 | NMC | 4 | 5 | 75 | LPS2 | 3 | 10 | 21 | AB1 | 0.04 | 60 | 3 | 7.7 |
| P-14 | NMC | 4 | 5 | 75 | LPS2 | 3 | 10 | 23 | AB1 | 0.04 | 60 | 1 | 6.7 |
| P-15 | NMC | 4 | 5 | 75 | LPS2 | 3 | 10 | 24 | — | — | — | — | 6.2 |
| P-16 | NMC | 4 | 5 | 75 | LPS1 | 5 | 2.4 | 23 | AB1 | 0.04 | 60 | 1 | 4.9 |
| P-17 | NMC | 4 | 5 | 75 | LPS3 | 0.5 | 30 | 21 | AB1 | 0.04 | 60 | 3 | 11.9 |
| P-18 | NMC | 4 | 5 | 75 | LPS4 | 0.3 | 50 | 21 | AB1 | 0.04 | 60 | 3 | 16.1 |
| P-19 | NMC | 4 | 5 | 75 | LPS2 | 3 | 10 | 21 | A32 | 0.04 | 140 | 3 | 10.1 |
| P-20 | NMC | 4 | 5 | 75 | LPS2 | 3 | 10 | 21 | AB1 | 0.04 | 60 | 3 | 7.7 |
| P-21 | NMC | 4 | 5 | 75 | LPS2 | 3 | 10 | 22 | AB1 | 0.04 | 60 | 3 | 7.8 |
| P-22 | NMC | 4 | 5 | 75 | LPS2 | 3 | 10 | 20.5 | AB1 | 0.04 | 60 | 3 | 7.6 |
| P-23 | NMC | 4 | 5 | 75 | LPS2 | 3 | 10 | 20 | AB1 | 0.04 | 60 | 3 | 7.6 |
| P-24 | NMC | 4 | 5 | 75 | LPS2 | 3 | 10 | 21 | AB1 | 0.04 | 60 | 3 | 7.7 |

| | Binder solution (B1) | | | | | Binder dispersion liquid (B2 | | | |
|---|---|---|---|---|---|---|---|---|---|
| Composition | | | Polarity | | | | | Polarity | |
| No. | Structure | M_{w} | element | SP value | Content | Structure | M_{w} | element | Content |
| P-1 | — | — | — | — | — | — | — | — | 0 |
| P-2 | B-1A | 6,000 | 0.6 | 18.9 | 1 | — | — | — | 1 |
| P-3 | B-1B | 120,000 | 0.6 | 18.9 | 1 | — | — | — | 1 |
| P-4 | B-1C | 200,000 | 0.6 | 18.9 | 1 | — | — | — | 1 |
| P-5 | B-1D | 400,000 | 0.6 | 18.9 | 1 | — | — | — | 1 |
| P-6 | B-1E | 1,000,000 | 0.6 | 18.9 | 1 | — | — | — | 1 |
| P-7 | B-1F | 2,500,000 | 0.6 | 18.9 | 1 | — | — | — | 1 |
| P-8 | B-2 | 400,000 | 0.0 | 12.0 | 1 | — | — | — | 1 |
| P-9 | B-2 | 400,000 | 0.0 | 12.0 | 1 | — | — | — | 1 |
| P-10 | B-2 | 400,000 | 0.0 | 12.0 | 1 | — | — | — | 1 |
| P-11 | B-1B | 120,000 | 0.6 | 18.9 | 1 | — | — | — | 1 |
| P-12 | B-3 | 400,000 | 1.0 | 18.4 | 1 | — | — | — | 1 |
| P-13 | B-4 | 400,000 | 3.0 | 17.9 | 1 | — | — | — | 1 |
| P-14 | B-1D | 400,000 | 0.6 | 18.9 | 1 | — | — | — | 1 |
| P-15 | B-1D | 400,000 | 0.6 | 18.9 | 1 | — | — | — | 1 |
| P-16 | B-1D | 400,000 | 0.6 | 18.9 | 1 | — | — | — | 1 |
| P-17 | B-1D | 400,000 | 0.6 | 18.9 | 1 | — | — | — | 1 |
| P-18 | B-1D | 400,000 | 0.6 | 18.9 | 1 | — | — | — | 1 |
| P-19 | B-1D | 400,000 | 0.6 | 18.9 | 1 | — | — | — | 1 |
| P-20 | B-1D | 400,000 | 0.6 | 18.9 | 0.5 | B-5 | 130,000 | 0 | 0.5 |
| P-21 | — | — | — | — | — | T-1 | 60,000 | 0.6 | 1 |
| P-22 | B-3 | 400,000 | 1.0 | 18.4 | 1.5 | — | — | — | — |
| P-23 | B-3 | 400,000 | 1.0 | 18.4 | 2.0 | — | — | — | — |
| P-24 | B-9 | 300,000 | 0.5 | 18.3 | 1 | — | — | — | — |

| | | | | Viscosity | | | |
|---|---|---|---|---|---|---|---|
| Composition | Dispersion medium (D) | | Difference | | Approximate | Exponent | |
| No. | Kind | SP Value | in SP value | 25° C. | value | part | Note |
| P-1 | Toluene | 18.5 | — | 2050 | 13100 | 0.80 | Comparative |
| | | | | | | | Example |
| P-2 | | 18.5 | 0.4 | 800 | 4000 | 0.70 | Comparative |
| | | | | | | | Example |
| P-3 | | 18.5 | 0.4 | 1500 | 7000 | 0.67 | Example |
| P-4 | | 18.5 | 0.4 | 2450 | 10000 | 0.61 | Example |
| P-5 | | 18.5 | 0.4 | 3160 | 12000 | 0.53 | Example |
| P-6 | | 18.5 | 0.4 | 6450 | 25000 | 0.55 | Example |
| P-7 | | 18.5 | 0.4 | 7030 | 30000 | 0.63 | Comparative |
| | | | | | | | Example |
| P-8 | | 18.5 | 6.5 | 2060 | 13000 | 0.80 | Comparative |
| | | | | | | | Example |
| P-9 | NMP | 25.4 | 13.4 | 2060 | 13000 | 0.80 | Comparative |
| | | | | | | | Example |
| P-10 | NMP | 25.4 | 13.4 | 2060 | 13000 | 0.80 | Comparative |
| | | | | | | | Example |
| P-11 | NMP | 25.4 | 6.5 | 2390 | 12000 | 0.70 | Example |
| P-12 | | 18.5 | 0.1 | 3540 | 12000 | 0.53 | Example |
| P-13 | | 18.5 | 0.6 | 4600 | 13000 | 0.45 | Example |
| P-14 | | 18.5 | 0.4 | 2310 | 8200 | 0.55 | Example |
| P-15 | | 18.5 | 0.4 | 1210 | 4000 | 0.52 | Comparative |
| | | | | | | | Example |
| P-16 | | 18.5 | 0.4 | 2720 | 13000 | 0.68 | Comparative |
| | | | | | | | Example |
| P-17 | | 18.5 | 0.4 | 4560 | 12000 | 0.45 | Example |
| P-18 | | 18.5 | 0.4 | 2720 | 13000 | 0.68 | Comparative |
| | | | | | | | Example |
| P-19 | | 18.5 | 0.4 | 4360 | 12000 | 0.45 | Example |
| P-20 | | 18.5 | 0.4 | 4260 | 12000 | 0.45 | Example |
| P-21 | | 18.5 | — | 2370 | 11900 | 0.70 | Comparative |
| | | | | | | | Example |
| P-22 | | 18.5 | 0.1 | 5540 | 12000 | 0.53 | Example |
| P-23 | | 18.5 | 0.1 | 5540 | 12000 | 0.53 | Comparative |
| | | | | | | | Example |
| P-24 | | 18.5 | 0.5 | 3010 | 12000 | 0.60 | Example |

| | | | | | | | | | | | | | Specific |
|---|---|---|---|---|---|---|---|---|---|---|---|---|---|
| | Positive electrode active material (AC) | | | | Inorganic solid electrolyte (SE) | | | | Conductive auxillary agent (CA) | | | | surface |
| | | | Specific | | | | Specific | | | | Specific | | area of |
| | | Particle | surface | | | Particle | surface | | | Particle | surface | | forming |
| Composition | Kind | diameter | area | Content | Kind | diameter | area | Content | Kind | diameter | area | Content | mixture |
| N-1 | Si | 2.5 | 2.8 | 50 | LPS2 | 3 | 10 | 45 | AB1 | 0.04 | 60 | 4 | 8.3 |
| N-2 | Si | 2.5 | 2.8 | 50 | LPS2 | 3 | 10 | 45 | AB1 | 0.04 | 60 | 4 | 8.3 |
| N-3 | Si | 2.5 | 2.8 | 50 | LPS2 | 3 | 10 | 45 | AB1 | 0.04 | 60 | 4 | 8.3 |
| N-4 | Si | 2.5 | 2.8 | 50 | LPS2 | 3 | 10 | 45 | AB1 | 0.04 | 60 | 4 | 8.3 |
| N-5 | Si | 2.5 | 2.8 | 50 | LPS2 | 3 | 10 | 45 | AB1 | 0.04 | 60 | 4 | 8.3 |
| N-6 | Si | 2.5 | 2.8 | 50 | LLZ | 3 | 8 | 45 | AB1 | 0.04 | 60 | 4 | 7.4 |
| N-7 | Si | 2.5 | 2.8 | 50 | LLZ | 3 | 8 | 45 | AB1 | 0.04 | 60 | 4 | 7.4 |
| N-8 | Si | 2.5 | 2.8 | 50 | LLZ | 3 | 8 | 45 | AB1 | 0.04 | 60 | 4 | 7.4 |
| N-9 | Si | 2.5 | 2.8 | 50 | LLZ | 3 | 8 | 45 | AB1 | 0.04 | 60 | 4 | 7.4 |
| N-10 | Si | 2.5 | 2.8 | 50 | LLZ | 3 | 8 | 45 | AB1 | 0.04 | 60 | 4 | 7.4 |

| | Binder solution (B1) | | | | | Dispersion medium | |
|---|---|---|---|---|---|---|---|
| | | | Polarity | | Approximate | Exponent | SP |
| Composition | Structure | M_{W} | element | 25° C. | value | part | value |
| N-1 | B-2 | 400,000 | 0.0 | 12.0 | 1 | NMP | 25.4 |
| N-2 | B-1D | 400,000 | 0.6 | 18.9 | 1 | NMP | 25.4 |
| N-3 | B-1D | 400,000 | 0.6 | 18.9 | 1 | Xylene | 18.7 |
| N-4 | B-3 | 400,000 | 1.0 | 18.4 | 1 | Xylene | 18.7 |
| N-5 | B-14 | 410,000 | 0.6 | 18.9 | 1 | Xylene | 18.7 |
| N-6 | B-2 | 400,000 | 0.0 | 12.0 | 1 | NMP | 25.4 |
| N-7 | B-1D | 400,000 | 0.6 | 18.9 | 1 | NMP | 25.4 |
| N-3 | B-1D | 400,000 | 0.6 | 18.9 | 1 | Xylene | 18.7 |
| N-9 | B-3 | 400,000 | 1.0 | 18.4 | 1 | Xylene | 18.7 |
| N-10 | B-14 | 410,000 | 0.6 | 18.9 | 1 | Xylene | 18.7 |

| | | Viscosity | | | |
|---|---|---|---|---|---|
| | Difference | | Approximate | Exponent | |
| Composition | in SP value | 25° C. | value | part | Note |
| N-1 | 13.4 | 4280 | 23000 | 0.73 | Comparative |
| | | | | | Example |
| N-2 | 6.5 | 4770 | 19000 | 0.60 | Example |
| N-3 | 0.2 | 3660 | 13000 | 0.55 | Example |
| N-4 | 0.3 | 4260 | 12000 | 0.45 | Example |
| N-5 | 0.2 | 3950 | 12500 | 0.50 | Example |
| N-6 | 13.4 | 4280 | 23000 | 0.73 | Comparative |
| | | | | | Example |
| N-7 | 6.5 | 4770 | 19000 | 0.60 | Example |
| N-3 | 0.2 | 3660 | 13000 | 0.55 | Example |
| N-9 | 0.3 | 4260 | 12000 | 0.45 | Example |
| N-10 | 0.2 | 3950 | 12500 | 0.50 | Example |

### Abbreviations in Table

NMC: LiNi_{1/3}Co_{1/3}Mn_{1/3}O₂
LPS1 to LPS4: LPS1 to LPS4 synthesized in Synthesis Examples S-1 to S-4
AB1: Acetylene black (manufactured by Denka Company Limited, specific surface area: 60 m²/g)
AB2: acetylene black (manufactured by Denka Company Limited, specific surface area: 140 m²/g)
NMP: N-methylpyrrolidone
Si: Silicon (manufactured by Sigma-Aldrich Co., LLC)
LLZ: Li₇La₃Zr₂O₁₂ (manufactured by Toshima Manufacturing Co., Ltd.)
Xylene: a mixture of xylene isomers in which the mixing molar ratio between isomers is, ortho-isomer:para-isomer:meta-isomer=1:5:2

<Production of Positive Electrode Sheet for all-Solid State Secondary Battery>

Each of the positive electrode compositions P-1 to P-24 obtained as above is applied onto an aluminum foil having a thickness of 20 μm by using a baker type applicator (product name: SA-201, manufactured by Tester Sangyo Co., Ltd.), followed by heating at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets P-1 to P-24 for an all-solid state secondary battery, having a positive electrode active material layer having a film thickness of 100 μm.

<Production of Negative Electrode Sheet for all-Solid State Secondary Battery>

Each of the negative electrode compositions N-1 to N-10 obtained as above is applied onto a copper foil having a thickness of 20 μm using a baker type applicator (product name: SA-201), followed by heating at 110° C. and subsequently drying and heating at 110° C. for 2 hours with a vacuum dryer AVO-200NS (product name, manufactured by AS ONE Corporation) to dry (to remove the dispersion medium) the negative electrode composition. Then, using a heat press machine, the dried negative electrode composition was pressurized (10 MPa, 1 minute) at 25° C. to produce each of negative electrode sheets N-1 to N-10 for an all-solid state secondary battery, having a negative electrode active material layer having a film thickness of 70 μm.

The following evaluations were carried out for each of the manufactured compositions and each of the sheets, and the results are shown in Table 4-1 and Table 4-2 (may be collectively referred to as Table 4).

<Evaluation 1: Dispersibility (Dispersion Characteristics)>

Each of the prepared compositions (slurries) was dropped in a groove of a particle size measuring device (a grind meter) 232/III type (product name, manufactured by AS ONE Corporation), and a value obtained by reading, according to the gradation, the position of the line that appeared after scraping with a scraper was defined as the aggregation size X. On the other hand, the aggregation size X₀ of the composition in which the viscosity was adjusted to 100 cP was measured in the same manner as the aggregation size X. The aggregation size ratio [X/X₀] was calculated using the obtained aggregation sizes X and X₀.

It is noted that the composition having a viscosity of 100 cP was prepared by adjusting the amount of a solvent while keeping the blending ratio of the solid content unchanged with respect to each sampled composition (slurry). As described above, the viscosity is a value measured using an E-type viscometer.

The ease of aggregation of solid particles was evaluated as the dispersibility of the composition by determining where this aggregation size ratio [X/X₀] is included in any one of the following evaluation standards.

In this test, the smaller the aggregation size ratio [X/X₀] is, the less the solid particles are aggregated or sedimented, which indicates that the dispersibility is excellent, and an evaluation standard “F” or higher is the pass level.

—Evaluation Standards—
A: X/X₀<1.05
B: 1.05≤X/X₀<1.10
C: 1.10≤X/X₀<1.15
D: 1.15≤X/X₀<1.20
E: 1.20≤X/X₀<1.30
F: 1.30≤X/X₀<1.50
G: 1.50≤X/X₀

<Evaluation 2: Storage Stability (Dispersion Characteristics)>

Each of the prepared compositions (slurries) was put into a glass test tube having a diameter of 10 mm and a height of 4 cm up to a height of 4 cm and allowed to stand at 25° C. for 24 hours. The solid content reduction rate for the upper 25% (in terms of height) of the composition before and after standing was calculated from the following expression. The ease of sedimentation (sedimentary property) of the solid particles due to a lapse of time was evaluated as the dispersion stability (the storage stability) of the composition by determining where the solid content reduction rate is included in any one of the following evaluation standards. In this test, the smaller the solid content reduction rate is, the better the dispersion stability is, and an evaluation standard “F” or higher is the pass level.

Solid content reduction rate (%)=[(concentration of solid contents of upper 25% before standing-concentration of solid contents of upper 25% after standing)/concentration of solid contents of upper 25% before standing]×100

—Evaluation Standards—
A: Solid content reduction rate<0.5%
B: 0.5%≤solid content reduction rate<2%
C: 2%≤solid content reduction rate<5%
D: 5%≤solid content reduction rate<10%
E: 10%≤solid content reduction rate<15%
F: 15%≤solid content reduction rate<20%
G: 20%≤solid content reduction rate

<Evaluation 3: Surface Properties (Application Suitability)>

As a surface property test for each composition, an arithmetic average roughness Ra of the surface of the active material layer of each obtained sheet was measured and evaluated.

Specifically, the arithmetic average roughness Ra of the surface of the active material layer of each sheet was measured with the following measuring device and under the following conditions according to Japanese Industrial Standards (JIS) B 0601: 2013.

The ease of forming a constitutional layer having a flat surface and good surface properties (surface properties) was evaluated as the application suitability of the composition, by determining where the arithmetic average roughness Ra is included in any of the following evaluation standards. In this test, the smaller the arithmetic average roughness Ra is, the more excellent the application suitability (the surface properties) is, and an evaluation standard “F” or higher is the pass level.

—Measuring Device and Conditions—
Measuring device: Three-dimensional fine shape measuring instrument (model: ET-4000A, manufactured by Kosaka Laboratory Ltd.)
Analytical instrument: 3D surface roughness analysis system (model TDA-31)
Touch needle: Tip radius of 0.5 μm, made of diamond
Needle pressure: 1 μN
Measurement length: 5.0 mm
Measurement speed: 0.02 mm/s
Measurement spacing: 0.62 μm
Cutoff: None
Filter method: Gaussian spatial type
Leveling: Present (quadratic curve)

—Evaluation Standards—
A: Ra<0.5 μm
B: 0.5 μm≤Ra<1.0 μm
C: 1.0 μm≤Ra<2.0 μm
D: 2.0 μm≤Ra<5.0 μm
E: 5.0 μm≤Ra<8.0 μm
F: 8.0 μm≤Ra<10 μm
G: 10 μm≤Ra

<Evaluation 4: Application Suitability (Adhesiveness)>

As the application suitability of each composition, the adhesiveness of the solid particles in the active material layer of each obtained electrode sheet and the adhesiveness between the active material layer and the collector were evaluated.

The produced sheet was cut out into a rectangle having a width of 3 cm and a length of 14 cm. Using a cylindrical mandrel tester (product code: 056, mandrel diameter: 10 mm, manufactured by Allgood Co., Ltd.), one end part of the cut-out sheet test piece in the length direction was fixed to the tester and disposed so that the cylindrical mandrel touched to the central portion of the sheet test piece, and then the sheet test piece was bent by 180° along the peripheral surface of the mandrel (with the mandrel as an axis) while pulling the other end part of the sheet test piece in the length direction with a force of 5N along the length direction. It is noted that the sheet test piece was set so that the active material layer thereof was placed on a side opposite to the mandrel (the base material or the collector was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the occurrence of defects (cracking, breakage, chipping, and the like) due to the disintegration of binding of solid particles in the active material layer and the minimum diameter at which the peeling between the active material layer and the collector could not be confirmed were measured, and the evaluation was carried out by determining which evaluation standard below is satisfied by the minimum diameter.

In this test, it is indicated that the smaller the minimum diameter is, the more firm the adhesive force of the solid particles that constitute the active material layer is, and the more firm the adhesion between the active material layer and the collector is, and an evaluation standard “F” or higher is the pass level.

—Evaluation Standards—
A: Minimum diameter<4 mm
B: 4 mm≤minimum diameter<6 mm
C: 6 mm≤minimum diameter<8 mm
D: 8 mm≤minimum diameter<10 mm
E: 10 mm≤minimum diameter<14 mm
F: 14 mm≤minimum diameter<25 mm
G: 25 mm≤minimum diameter

<Evaluation 5: Upper Limit Concentration for Slurrying>

In the preparation of each of the above-described compositions (slurries), the blending amount of each of the dispersion media shown in Table 2 and Table 3 was adjusted to prepare a test composition having a concentration of solid contents of 76% by mass in the composition. The prepared test composition having a concentration of solid contents of 76% by mass was placed in a container (a columnar container (diameter: 5.0 cm, height: 7.0 cm) for a self-rotation type mixer (ARE-310: product name, manufactured by THINKY CORPORATION) placed on a desk, to a height of about 1.0 cm, and then tilted by 60 degrees (with respect to the vertical direction) from this state, and it was checked whether or not the fluidity was such a degree that the prepared composition dripped (undergo variation) under the weight thereof within 10 seconds. In a case where the test composition did not drip (undergo no variation) under the weight thereof and had no fluidity, the dispersion medium was added so that the concentration of solid contents of the test composition was reduced by 1% by mass, the test composition was dispersed at 2,000 rpm for 1 minute with the above-described self-rotation type mixer, and then it was checked whether or not the test composition had fluidity in the same manner as in the case of the above-described test composition having a concentration of solid contents of 76% by mass. This operation was repeated so that the concentration of solid contents was reduced by 1% by mass per operation, and the maximum concentration of the concentrated slurry capable of being prepared was evaluated regarding the maximum concentration of solid contents having fluidity as the upper limit concentration for slurrying. This test was carried out in an environment of 25° C.

In a case where the concentration of solid contents is increased to a concentration exceeding the upper limit concentration for slurrying, it is difficult to be used in the application (coating) step in the first place. Therefore, the upper limit concentration for slurrying is an indicator of the upper limit concentration of solid contents of the composition that can be used in the coating step, and it is preferable to be high.

In Table 4 below, the unit of the upper limit concentration for slurrying, which is % by mass, is omitted.

TABLE 4

| | | | | | Upper limit | |
|---|---|---|---|---|---|---|
| | | Storage | Surface | | concentration for | |
| No. | Dispersibility | stability | properties | Adhesiveness | slurry | Note |
| P-1 | G | G | G | G | 50 | Comparative |
| | | | | | | Example |
| P-2 | G | G | E | E | 50 | Comparative |
| | | | | | | Example |
| P-3 | D | F | E | E | 60 | Example |
| P-4 | C | C | C | C | 67 | Example |
| P-5 | B | B | B | C | 70 | Example |
| P-6 | D | E | D | D | 60 | Example |
| P-7 | G | E | G | G | 50 | Comparative |
| | | | | | | Example |
| P-8 | G | G | G | G | 50 | Comparative |
| | | | | | | Example |
| P-9 | G | G | G | G | 50 | Comparative |
| | | | | | | Example |
| P-10 | G | G | G | G | 50 | Comparative |
| | | | | | | Example |
| P-11 | E | E | E | E | 58 | Example |
| P-12 | A | A | A | B | 74 | Example |
| P-13 | A | A | A | B | 74 | Example |
| P-14 | B | B | B | B | 71 | Example |
| P-15 | F | G | D | D | 55 | Comparative |
| | | | | | | Example |
| P-16 | G | F | G | G | 55 | Comparative |
| | | | | | | Example |
| P-17 | A | A | A | B | 74 | Example |
| P-18 | G | F | G | G | 50 | Comparative |
| | | | | | | Example |
| P-19 | A | A | A | B | 74 | Example |
| P-20 | A | A | A | A | 74 | Example |
| P-21 | G | B | G | G | 53 | Comparative |
| | | | | | | Example |
| P-22 | A | A | A | B | 74 | Example |
| P-23 | G | F | G | G | 50 | Comparative |
| | | | | | | Example |
| P-24 | C | D | C | C | 60 | Example |

| | | | | | Upper limit | |
|---|---|---|---|---|---|---|
| | Slurry | Storage | Surface | | concentration for | |
| No. | dispersibility | stability | properties | Adhesiveness | slurry | Note |
| N-1 | G | G | G | G | 55 | Comparative Example |
| N-2 | D | D | D | D | 60 | Example |
| N-3 | C | C | C | C | 65 | Example |
| N-4 | A | A | A | B | 73 | Example |
| N-5 | B | A | C | C | 68 | Example |
| N-6 | G | G | G | G | 55 | Comparative Example |
| N-7 | D | D | D | E | 60 | Example |
| N-8 | C | C | C | C | 65 | Example |
| N-9 | A | A | A | B | 72 | Example |
| N-10 | B | A | C | C | 68 | Example |

<Manufacturing of all-Solid State Secondary Battery>

A positive electrode sheet for an all-solid state secondary battery, a solid electrolyte sheet for an all-solid state secondary battery, and a negative electrode sheet for an all-solid state secondary battery were used in combinations of the constitutional layers shown in Table 5-1 and Table 5-2 (collectively referred to as Table 5) to manufacture all-solid state secondary battery.

(Preparation of Inorganic Solid Electrolyte-Containing Composition (Slurry)

2.8 g of the LPS2 synthesized in Synthesis Example S-2, 0.08 g (in terms of solid content mass) of the binder B-1D solution prepared as above, and the butyl butyrate as the dispersion medium shown in the table below were put into a container for a self-rotation type mixer (ARE-310, manufactured by THINKY CORPORATION) so that the content of the dispersion medium in the composition was 50% by mass. Then, this container was set in a self-rotation type mixer ARE-310 (product name). Mixing was carried out under the conditions of 25° C. and a rotation speed of 2,000 rpm for 5 minutes to prepare an inorganic solid electrolyte-containing composition (slurry) S-1.

The contents of the respective components in the composition were 97.2% by mass for LPS2 and 2.8% by mass for the binder in 100% by mass of the solid content.

(Production of Solid Electrolyte Sheet for all-Solid State Secondary Battery)

Using a baker type applicator (product name: SA-201, manufactured by Tester Sangyo Co., Ltd.), the inorganic solid electrolyte-containing composition S-1 obtained as above was applied on an aluminum foil having a thickness of 20 μm, and heating was carried out at 110° C. for 2 hours to dry (remove the dispersion medium) the inorganic solid electrolyte-containing composition. Then, using a heat press machine, the inorganic solid electrolyte-containing composition dried at 25° C. and a pressure of 10 MPa for 10 seconds was pressurized to produce a solid electrolyte sheet S-1 for an all-solid state secondary battery. The film thickness of the solid electrolyte layer was 50 μm.

(Manufacture of all-Solid State Secondary Battery)

The positive electrode sheet for an all-solid state secondary battery, shown in the column of “Positive electrode sheet No.” in Table 5 was punched out into a disk shape having a diameter of 10 mm and was placed in a cylinder made of PET having an inner diameter of 10 mm. The solid electrolyte sheet S-1 for an all-solid state secondary battery was punched on the positive electrode active material layer side in the cylinder into a disk shape having a diameter of 10 mm and placed in the cylinder, and a 10 mm SUS rod was inserted from the openings at both ends of the cylinder. The collector side of the positive electrode sheet for an all-solid state secondary battery and the aluminum foil side of the solid electrolyte sheet for an all-solid state secondary battery were pressurized by applying a pressure of 350 MPa with an SUS rod. The SUS rod on the side of the solid electrolyte sheet for an all-solid state secondary battery was once removed to gently peel off the aluminum foil of the solid electrolyte sheet for an all-solid state secondary battery, and then the negative electrode sheet for an all-solid state secondary battery, shown in the column of “Negative electrode sheet No.” in Table 5, was punched out into a disk shape having a diameter of 10 mm and inserted onto the solid electrolyte layer of the solid electrolyte sheet for an all-solid state secondary battery in the cylinder. The removed SUS rod was inserted again into the cylinder and the sheets were fixed while applying a pressure of 50 MPa. In this way, all-solid state secondary battery Nos. C-1 to C-34 having a lamination configuration of an aluminum foil (thickness: 20 μm)-a positive electrode active material layer (thickness: 90 μm)-a solid electrolyte layer (thickness: 45 μm)-a negative electrode active material layer (thickness: 65 μm)-a copper foil (thickness: 20 μm) were obtained.

<Evaluation 5: Rate Characteristics>

The rate characteristic of each of the manufactured all-solid state secondary batteries was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 4.2 V. Then, the battery was discharged at a current density of 0.1 mA/cm² until the battery voltage reached 2.5 V. Then, the charging was carried out again at a current density of 0.1 mA/cm² until the battery voltage reached 4.2 V, and then the discharging was carried out at a current density of 4.2 mA/cm² until the battery voltage reached 2.5 V. The rate characteristics were determined according to the following expression and applied to the following evaluation standards to evaluate the rate characteristics of the all-solid state secondary battery. In this test, the higher the evaluation standard, the better the battery performance (rate characteristics), and the original battery performance can be exhibited even in a case where discharging is carried out at a high speed. In this test, an evaluation standard of “F” or higher is the pass level.

$$Rate characteristics ( \% ) = ( discharge capacity at 4.2 mA / {cm}^{2} / discharge capacity at 0.1 mA / {cm}^{2} ) \times 100$$

—Evaluation Standards—
A: 90%≤rate characteristics
B: 80%≤rate characteristics<90%
C: 70%≤rate characteristics<80%
D: 60%≤rate characteristics<70%
E: 50%≤rate characteristics<60%
F: 30%≤rate characteristics<50%
G: Rate characteristics<30%

TABLE 5-1

| | | Solid | | | |
|---|---|---|---|---|---|
| | Positive | electrolyte | Negative | | |
| | electrode | laminated | electrode | Rate | |
| Battery | sheet | sheet | sheet | charac- | |
| No. | No. | No. | No. | teristics | Note |
| C-1 | P-1 | S-1 | N-1 | G | Comparative |
| | | | | | Example |
| C-2 | P-2 | S-1 | N-1 | G | Comparative |
| | | | | | Example |
| C-3 | P-3 | S-1 | N-1 | F | Example |
| C-4 | P-4 | S-1 | N-1 | C | Example |
| C-5 | P-5 | S-1 | N-1 | B | Example |
| C-6 | P-6 | S-1 | N-1 | E | Example |
| C-7 | P-7 | S-1 | N-1 | G | Comparative |
| | | | | | Example |
| C-8 | P-8 | S-1 | N-1 | G | Comparative |
| | | | | | Example |
| C-9 | P-9 | S-1 | N-1 | G | Comparative |
| | | | | | Example |
| C-10 | P-10 | S-1 | N-1 | G | Comparative |
| | | | | | Example |
| C-11 | P-11 | S-1 | N-1 | D | Example |
| C-12 | P-12 | S-1 | N-1 | A | Example |
| C-13 | P-13 | S-1 | N-1 | A | Example |
| C-14 | P-14 | S-1 | N-1 | B | Example |
| C-15 | P-15 | S-1 | N-1 | G | Comparative |
| | | | | | Example |
| C-16 | P-16 | S-1 | N-1 | G | Comparative |
| | | | | | Example |
| C-17 | P-17 | S-1 | N-1 | A | Example |
| C-18 | P-18 | S-1 | N-1 | G | Comparative |
| | | | | | Example |
| C-19 | P-19 | S-1 | N-1 | A | Example |
| C-20 | P-20 | S-1 | N-1 | A | Example |
| C-21 | P-21 | S-1 | N-1 | G | Comparative |
| | | | | | Example |
| C-22 | P-22 | S-1 | N-1 | C | Example |
| C-23 | P-23 | S-1 | N-1 | G | Comparative |
| | | | | | Example |
| C-24 | P-24 | S-1 | N-1 | D | Example |
| C-25 | P-1 | S-1 | N-1 | G | Comparative |
| | | | | | Example |
| C-26 | P-1 | S-1 | N-2 | E | Example |
| C-27 | P-1 | S-1 | N-3 | C | Example |
| C-28 | P-1 | S-1 | N-4 | A | Example |
| C-29 | P-1 | S-1 | N-5 | B | Example |
| C-30 | P-1 | S-1 | N-6 | G | Comparative |
| | | | | | Example |
| C-31 | P-1 | S-1 | N-7 | E | Example |
| C-32 | P-1 | S-1 | N-8 | C | Example |
| C-33 | P-1 | S-1 | N-9 | A | Example |
| C-34 | P-1 | S-1 | N-10 | B | Example |

The following findings can be seen from the results of Table 4 and Table 5.

All of the electrode compositions P-1, P-21 and P-15 of Comparative Examples which do not contain the binder (B1) or the conductive auxiliary agent and the electrode compositions P-2, P-7 to P-10, P-16, P-18, P-23, N-1, and N-6 of Comparative Examples which do not satisfy any of the conditions (1) to (4) even in a case where the binder (B1) is contained cannot achieve the dispersion characteristics and the application suitability at the same time. As a result, an all-solid state secondary battery including the active material layer formed of each of these electrode compositions is inferior in rate characteristics.

On the other hand, the electrode composition which contains the inorganic solid electrolyte (SE), the active material (AC), the conductive auxiliary agent (CA), the dispersion medium (D), and the polymer binder (B1) that dissolves in this dispersion medium and which satisfies the conditions (1) to (4) makes it possible to achieve both excellent dispersion characteristics and excellent application suitability even in a case where the concentration of solid contents is increased. An all-solid state secondary battery including the active material layer formed of each of these electrode compositions can realize sufficient rate characteristics.

In addition, from the above results, it can see that in the electrode composition containing the inorganic solid electrolyte (SE), the active material (AC), the conductive auxiliary agent (CA), and the dispersion medium (D), the polymers B-6 to B-8 and B-10 to 13 shown in Table 1 can also form the polymer binder (B1) that dissolves in the dispersion medium (D), and in a case of being used in combination with each of the above-described components so that the condition (1) and the condition (2) are satisfied, and in addition, the conditions (3) and (4) are satisfied, these polymers make it possible to achieve both excellent dispersion characteristics and excellent application suitability even in a case where the concentration of solid contents is increased.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery

What is claimed is:

1. An electrode composition comprising:
an inorganic solid electrolyte (SE) having an ion conductivity of a metal belonging to Group 1 or Group 2 of the periodic table;
an active material (AC);
a conductive auxiliary agent (CA);
a polymer binder (B); and
a dispersion medium (D),
wherein the polymer binder (B) includes a polymer binder (B1) that is dissolved in the dispersion medium (D), and
the polymer binder (B1), the inorganic solid electrolyte (SE), the active material (AC), and the conductive auxiliary agent (CA) satisfy the following conditions (1) to (4),
(1) a mass average molecular weight of a polymer constituting the polymer binder (B1) is 100,000 to 2,000,000,
(2) a value of a polarity element of surface energy of the polymer constituting the polymer binder (B1) is 0.5 mJ/m² or more,
(3) a content of the polymer binder (B1) in a total solid content is 1.5% by mass or less,
(4) a total product of a specific surface area and a content mass fraction of each of the inorganic solid electrolyte (SE), the active material (AC), and the conductive auxiliary agent (CA) is 5.0 to 15.0 m²/g.

2. The electrode composition according to claim 1,
wherein the dispersion medium (D) has an SP value of 17 to 22 MPa^{1/2}.

3. The electrode composition according to claim 1,
wherein the value of the polarity element is 1.0 mJ/m² or more.

4. The electrode composition according to claim 1,
wherein the polymer constituting the polymer binder (B1) contains a constitutional component having a substituent having 8 or more carbon atoms, as a side chain.

5. The electrode composition according to claim 1,
wherein the polymer binder (B) includes a polymer binder (B2) composed of a polymer having a molecular weight different from that of the polymer binder (B1).

6. The electrode composition according to claim 5,
wherein the mass average molecular weight of the polymer constituting the polymer binder (B1) is 200,000 or more, and
a mass average molecular weight of the polymer constituting the polymer binder (B2) is 200,000 or less.

7. The electrode composition according to claim 1,
wherein in a case where a viscosity at a shear rate of 10 s⁻¹ and a viscosity at a shear rate of 20 s⁻¹ are measured for the electrode composition, and a power approximation expression is created in terms of orthogonal coordinates where a lateral axis indicates the shear rate and a vertical axis indicates the viscosity, an approximate value of a viscosity at a shear rate of 1 s⁻¹ is 5,000 cP or more, and an absolute value of an exponent part of the power approximation expression is 0.6 or less.

8. An electrode sheet for an all-solid state secondary battery, comprising:
an active material layer formed of the electrode composition according to claim 1.

9. An all-solid state secondary battery comprising, in the following order:
a positive electrode active material layer;
a solid electrolyte layer; and
a negative electrode active material layer,
wherein at least one layer of the positive electrode active material layer or the negative electrode active material layer is an active material layer formed of the electrode composition according to claim 1.

10. A manufacturing method for an electrode sheet for an all-solid state secondary battery, the manufacturing method comprising:
forming a film of the electrode composition according to claim 1.

11. A manufacturing method for an all-solid state secondary battery, the manufacturing method comprising:
manufacturing an all-solid state secondary battery through the manufacturing method according to claim 10.
